(19) United States
(12) Patent Application Publication
(10) Pub. No.: US 2011/0158054 A1
(43) Pub. Date: Jun. 30, 2011

(54) Stepping motor control circuit and analogue electronic watch

(76) Inventor: Saburo Manaka, Chiba-shi (JP)

(21) Appl. No.: 12/928,574

(22) Filed: Dec. 14, 2010

(30) Foreign Application Priority Data
Dec. 28, 2009 (JP) 2009-298743
Oct. 8, 2010 (JP) 2010-228977

(51) Int. Cl. G04B 19/04; H02P 8/38

(52) U.S. Cl. 368/80; 318/696

(57) ABSTRACT

The invention enables accurate detection of the state of rotation even when the timing of generation of a induced signal is changed due to the relative change of a drive energy with respect to a load. A plurality of types of detection segments are provided as the detection segments for detecting the state of rotation of a stepping motor, and a control circuit selects one of the detection segments, determines the state of rotation of the stepping motor using a detection pattern of an induced signal VRs in the selected detection segment according to the extent of the reserve driving capacity of a main drive pulse, and controls the driving of the stepping motor on the basis of any one of a plurality of the main drive pulses having energies different from each other or a correction drive pulse having energy larger than the respective main drive pulses on the basis of the result of determination.

### BACKGROUND OF THE INVENTION

1. Field of the Invention

The present invention relates to a stepping motor control circuit and an analogue electronic watch using the stepping motor control circuit.

2. Related Art

In the related art, a stepping motor including a stator having a rotor storage hole and a positioning portion for determining a stop position of a rotor, the rotor disposed in the rotor storage hole, and a coil, and being configured to rotate the rotor by causing the stator to generate a magnetic flux by supplying alternating signals to the coil and stop the same at a position corresponding to the positioning portion is used in an analogue electronic watch, for example.

A method employed as a method of controlling the stepping motor is a correction drive system configured to detect whether or not the stepping motor is rotated by detecting an induced signal VRs generated in the stepping motor when the stepping motor is driven with a main drive pulse P1 and, according to the result of detection of whether or not the stepping motor is rotated, change the pulse width of the main drive pulse P1 and drive the stepping motor with the changed main drive pulse P1 or forcedly rotate the stepping motor with a correction drive pulse P2 having a pulse width larger than that of the main drive pulse P1 (for example, JP-B-61-15385).

WO2005/119377 discloses a unit for comparatively discriminating the detected time and the reference time in addition to the detection of the induced signal when detecting the rotation of the stepping motor. If the detected signal is lower than a predetermined reference threshold voltage Vcomp after having rotated the stepping motor with a main drive pulse P11, the corrected drive pulse P2 is supplied, and the subsequent main drive pulse P1 is changed to a main drive pulse P12 having a larger energy than the main drive pulse P11 for driving the stepping motor (upgrade). If the detected time of the rotation with the main drive pulse P12 is earlier than the reference time, the main drive pulse P12 is changed to the main drive pulse P11 (downgrade). In this manner, the pulse is controlled to rotate the stepping motor with the main drive pulse P1 according to the load by determining the state of rotation of the stepping motor when being driven with the main drive pulse, so that the current consumption is reduced.

However, if an attempt is made to determine the state of rotation of the stepping motor only on the basis of whether the timing of generation of the induced signal VRs is earlier or later than the reference time, there arises a problem such that it is difficult to determine the state of rotation accurately when the energy of the main drive pulse is changed relatively with respect to the load.

### SUMMARY OF THE INVENTION

It is an aspect of the present invention to enable accurate detection of the state of rotation even when the timing of generation of the induced signal is changed due to the relative change of the drive energy with respect to the load.

According to the invention, there is provided a stepping motor control circuit including: a rotation detection unit configured to detect an induced signal generated by the rotation of a rotor of a stepping motor and detect whether or not the induced signal exceeds a predetermined reference threshold voltage in a detection segment having a plurality of segments; and a control unit configured to determine the state of rotation of the stepping motor on the basis of the pattern indicating whether or not the induced signals detected by the rotation detection unit in the plurality of segments exceed the reference threshold voltage and, on the basis of the result of detection, control the driving of the stepping motor with any one of a plurality of main drive pulses different from each other in energy or a correction drive pulse having larger energy than the main drive pulse, wherein a plurality types of the detection segments are provided as the detection segments, and the control unit selects one of the detection segments and determines the state of rotation of the stepping motor using the pattern in the selected detection segment according to the extent of the reserve driving capacity of the main drive pulse, and controls the driving of the stepping motor on the basis of any one of the plurality of main drive pulses having energies different from each other or the correction drive pulse having energy larger than the respective main drive pulses on the basis of the result of determination.

According to the invention, there is provided an analogue electronic watch having a stepping motor configured to rotate time-of-day hands, and a stepping motor control circuit configured to control the stepping motor, in which the above-described stepping motor control circuit is used as the stepping motor control circuit.

According to the motor control circuit in the invention, accurate detection of the state of rotation is enabled even when the timing of generation of the induced signal is changed due to the relative change of the drive energy with respect to the load.

According to an analogue electronic watch in the invention, accurate detection of the state of rotation and accurate clocking drive are enabled even when the timing of generation of an induced signal is changed due to the relative change of drive energy with respect to a load.

### BRIEF DESCRIPTION OF THE DRAWINGS

FIG. 1 is a block diagram common to a stepping motor control circuit and an analogue electronic watch according to respective embodiments of the invention;

FIG. 2 is a drawing showing a configuration of a stepping motor used in the analogue electronic watch according to respective embodiments of the invention;

FIG. 3 is a timing chart for explaining the action of the stepping motor control circuit and the analogue electronic watch according to a first embodiment of the invention;

FIG. 4 is a determination chart for explaining the action of the stepping motor control circuit and the analogue electronic watch according to the first embodiment of the invention;

FIG. 5 is a flowchart showing the action of the stepping motor control circuit and the analogue electronic watch according to the first embodiment of the invention;

FIG. 6 is a flowchart common to the stepping motor control circuit and the analogue electronic watch according to the respective embodiments of the invention;

FIG. 7 is a flowchart showing the action of the stepping motor control circuit and the analogue electronic watch according to a second embodiment of the invention;

FIG. 8 is a timing chart for explaining the action of the stepping motor control circuit and the analogue electronic watch according to a third embodiment of the invention;

FIG. 9 is a determination chart for explaining the action of the stepping motor control circuit and the analogue electronic watch according to the third embodiment of the invention;

FIG. 10 is a flowchart showing the action of the stepping motor control circuit and the analogue electronic watch according to the third embodiment of the invention;

FIG. 11 is a partly detailed circuit diagram of a drive pulse selection circuit and a rotation detection circuit used in the respective embodiments of the invention;

FIG. 12 is a partly detailed circuit diagram for explaining the action of the drive pulse selection circuit and the rotation detection circuit used in the respective embodiments of the invention;

FIG. 13 is a partly detailed circuit diagram for explaining the action of the drive pulse selection circuit and the rotation detection circuit used in the respective embodiments of the invention;

FIG. 14 is a timing chart for explaining the action of the stepping motor control circuit and the analogue electronic watch according to a fourth embodiment of the invention;

FIG. 15 is a flowchart showing the action of the stepping motor control circuit and the analogue electronic watch according to the fourth embodiment of the invention;

FIG. 16 is a flowchart showing the action of the stepping motor control circuit and the analogue electronic watch according to a fifth embodiment of the invention;

FIG. 17 is a timing chart for explaining the action of the stepping motor control circuit and the analogue electronic watch according to a sixth embodiment of the invention; and

FIG. 18 is a flowchart showing the action of the stepping motor control circuit and the analogue electronic watch according to the sixth embodiment of the invention.

### DESCRIPTION OF THE PREFERRED EMBODIMENTS

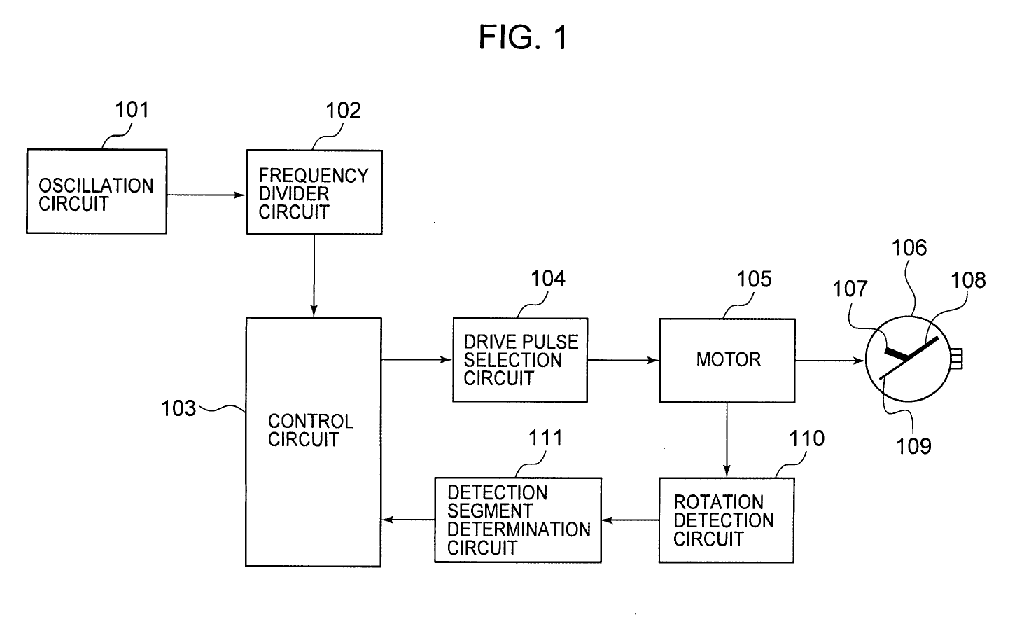

FIG. 1 is a block diagram common to analogue electronic watches using a motor control circuit according to respective embodiments of the invention, and shows an example of an analogue electronic wrist watch.

In FIG. 1, the analogue electronic watch includes an oscillation circuit 101 configured to generate signals of a predetermined frequency, a frequency divider circuit 102 configured to divide the frequency of the signals generated by the oscillation circuit 101 and generate a clock signal which serves as a reference when counting the time, a control circuit 103 configured to perform control of respective electronic circuit elements which constitute the electronic watch and control of drive pulse change, a drive pulse selection circuit 104 configured to select and output a drive pulse for rotating a motor on the basis of a control signal from the control circuit 103, a stepping motor 105 configured to be rotated by the drive pulse from the drive pulse selection circuit 104, and an analogue display unit 106 configured to be rotated by the stepping motor 105 and include a time-of-day hands indicating the time of day (three types; namely, a hour hand 107, a minute hand 108, and a second hand 109 in an example shown in FIG. 1).

The analogue electronic watch also includes a rotation detection circuit 110 configured to detect induced signals VRs which are generated by the rotation of the rotor of the stepping motor 105 and exceed a predetermined reference threshold voltage in a predetermined detection segment, and a detection segment determination circuit 111 configured to compare a timing and a segment where the rotation detection circuit 110 detects the induced signal VRs exceeding a reference threshold voltage Vcomp and determine the segment where the induced signal VRs is detected.

Although detailed description will be given later, a first detection segment Tx having a plurality of segments and a second detection segment Ty having a plurality of segments are provided as the detection segment, and the state of rotation is determined by selectively using either one of the first detection segment Tx or the second detection segment Ty according to the magnitude of the reserve driving capacity of the main drive pulse P1, thereby performing pulse control.

The rotation detection circuit 110 has a configuration in which the induced signal VRs is detected using the same principle as the rotation detection circuit described in JP-B-61-15385, and the reference threshold voltage Vcomp is set as follows. When the speed of the rotation is high as in the case where the stepping motor 105 rotates, the induced signal VRs exceeding the predetermined reference threshold voltage Vcomp is generated. When the speed of rotation is low as in the case where the motor 105 does not rotate, the induced signal VRs does not exceed the reference threshold voltage Vcomp.

The oscillation circuit 101 and the frequency divider circuit 102 constitute a signal generating unit, and the analogue display unit 106 constitutes a time-of-day display unit. The rotation detection circuit 110 constitutes a rotation detection unit, and the control circuit 103, the drive pulse selection circuit 104, and the detection segment determination circuit 111 constitute a control unit.

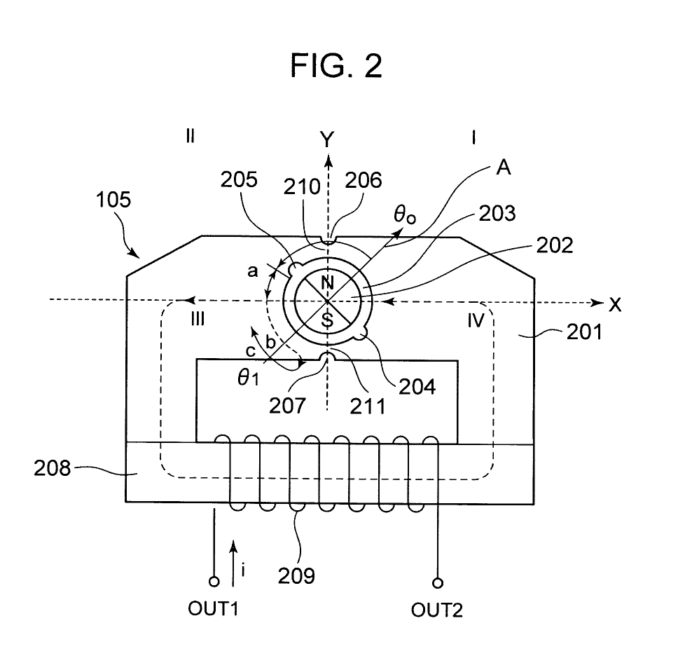

FIG. 2 is a configuration drawing of the stepping motor 105 which is used commonly in the respective embodiments of the invention, and shows an example of a stepping motor for a watch which is generally used in the analogue electronic watch.

In FIG. 2, the stepping motor 105 includes a stator 201 having a rotor storage through hole 203, a rotor 202 disposed in the rotor storage through hole 203 so as to be capable of rotating therein, a magnetic core 208 joined to the stator 201, and a coil 209 wound around the magnetic core 208. When the stepping motor 105 is used in the analogue electronic watch, the stator 201 and the magnetic core 208 are fixed to a base panel (not shown) with screws (not shown) and are joined to each other. The coil 209 has a first terminal OUT1 and a second terminal OUT2.

The rotor 202 is magnetized in two polarities (S-polar and N-polar). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that the magnetic resistance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for fixing the stop position of the rotor 202. In a state in which the coil 209 is not excited, the rotor 202 is stably stopped at a position corresponding to the above-described positioning portions, in other words, at a position (position at an angle of θ0) where the direction of an axis of magnetic pole A of the rotor 202 extends orthogonally to a segment connecting the notched portions 204 and 205 as shown in FIG. 2. An XY coordinate space extending around an axis of rotation (center of rotation) of the rotor 202 as a center is divided into four quadrants (first to fourth quadrants I to IV).

When the drive pulse selection circuit 104 supplies a rectangular drive pulse to between the terminals OUT1 and OUT2 of the coil 209 (for example, the first terminal OUT1 side is the positive pole and the second terminal OUT2 side is the negative pole), and allows a current i to flow in the direction indicated by an arrow in FIG. 2, a magnetic flux in the direction of an arrow of a broken line is generated in the stator 201. Accordingly, the saturable portions 210 and 211 are saturated and the magnetic resistance is increased, and then the rotor 202 rotates in a direction indicated by an arrow in FIG. 2 by 180° by a mutual action between a magnetic pole generated in the stator 201 and a magnetic pole of the rotor 202, and the axis of magnetic pole A stops stably at an angular position θ1. The direction of rotation (counterclockwise rotation in FIG. 2) for causing the stepping motor 105 to rotate and putting the same into a normal action (the movement of the time-of-day hands because the watch in this embodiment is an analogue electronic watch) is defined to be a normal direction and the reverse direction (clockwise direction) is defined to be a reverse direction.

Subsequently, when the drive pulse selection circuit 104 supplies rectangular drive pulses having reverse polarity to the terminals OUT1 and OUT2 of the coil 209 (the first terminal OUT1 side is the negative pole and the second terminal OUT2 side is the positive pole, so that the polarity is inverted from the driving described above), and allows a current to flow in the direction opposite from that indicated by an arrow in FIG. 2, a magnetic flux is generated in the stator 201 in the opposite direction from that indicated by an arrow of a broken line. Accordingly, the saturable portions 210 and 211 are saturated first, and then the rotor 202 rotates in the same direction (normal direction) as that described above by 180° by the mutual action between the magnetic pole generated in the stator 201 and the magnetic pole of the rotor 202, and the axis of magnetic pole A stops stably at a predetermined angular position θ0.

In this manner, by supplying the signals having different polarities (alternating signals) to the coil 209 from then onward, the action is repeatedly performed, so that the rotor 202 is rotated continuously in the direction indicated by an arrow by 180° each. In this embodiment, a plurality of main drive pulses P10 to P1m and a correction drive pulse P2 having energies different from each other are used as the drive pulses as described later.

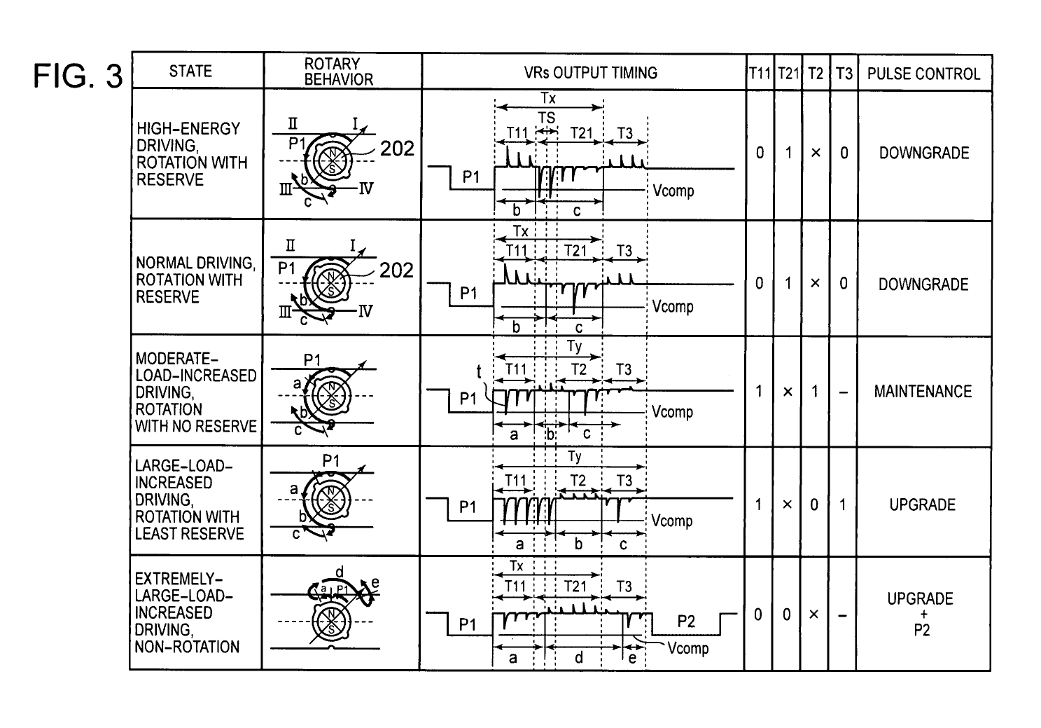

FIG. 3 is a timing chart showing a case where the stepping motor 105 is driven with a main drive pulse P1 in the first embodiment of the invention, in which the states of rotation of the stepping motor on the basis of the relative relationship between the energy of the main drive pulse P1 and the magnitude of the load, the rotary behaviors showing the rotational positions of the rotor 202, the timings when the induced signal VRs is generated, patterns showing the state of rotation including the reserve driving capacity, and pulse control actions such as the downgrade are also shown.

In FIG. 3, reference sign P1 designates the main drive pulse P1 and also a segment in which the rotor 202 is rotated with the main drive pulse P1. Reference signs a to e designate areas showing the rotational positions of the rotor 202 due to free vibrations after the stop of drive with the main drive pulse P1.

The control circuit 103 includes the first detection segment Tx having a plurality of segments (two segments T11, T21 in this embodiment) and the second detection segment Ty having a plurality of segments (three segments T11, T2, and T3 in this embodiment) as the detection segments, and determines the state of rotation by selectively using either one of the first detection segment Tx or the second detection segment Ty according to the magnitude of the relative reserve driving capacity of the main drive pulse P1 with respect to the load of the stepping motor 105, thereby performing pulse control.

The first detection segment Tx includes the first segment T11, which is a predetermined time immediately after the drive with the main drive pulse P1, and the second segment T21, which is a predetermined time after the first segment T11. In this manner, the first detection segment Tx starting immediately after the drive with the main drive pulse P1 is divided into the continuous plurality of segments.

The second detection segment Ty includes the first segment T11, which is a predetermined time immediately after the drive with the main drive pulse P1, the second segment T2, which is a predetermined time after the first segment T11, and the third segment T3, which is a predetermined time after the second segment T2.

The first segment T11 of the second detection segment Ty is also used as the first segment T11 of the first detection segment Tx. An ineffective area Ts is provided between the first segment T11 and the second segment T2 of the second detection segment Ty, so that the second segment T2 of the second detection segment Ty starts after the second segment T21 of the first detection segment Tx. The ineffective area Ts is an area in which the control circuit 103 determines the state of rotation of the stepping motor 105 without considering the induced signal VRs generated in the ineffective area Ts. The rotation detection circuit 110 detects the induced signal VRs generated by free vibrations of the stepping motor 105 at predetermined sampling intervals. Accordingly, what is necessary is only to avoid the induced signal VRs detected by only one sampling from being taken into consideration. Therefore, the time width of the ineffective area Ts may have any width as long as it is not smaller than the sampling intervals of the induced signal VRs.

In this embodiment, the first segment T11 of the second detection segment Ty is also used as the first segment T11 of the first detection segment Tx. However, it may be set to a segment having other lengths, for example, a segment having a length continuing from immediately after the termination of the drive with the main drive pulse P1 to the second segment T2. In this case, the first segment of the first detection segment Tx is set to have a time width shorter than the first segment T11 of the second detection segment Ty.

In this embodiment, the rotation detection circuit 110 detects the induced signal VRs exceeding the reference threshold voltage Vcomp in the detection segment Tx or Ty selected by the control circuit 103 on the basis of the reserve driving capacity, and the detection segment determination circuit 111 determines which segment the induced signal VRs exceeding the reference threshold voltage Vcomp detected by the rotation detection circuit 110 belongs. The control circuit 103 determines the state of rotation on the basis of the result determined by the detection segment determination circuit 111, thereby performing pulse control.

For example, if the control circuit 103 determines that the induced signal VRs exceeding the reference threshold voltage Vcomp is not detected in the first segment T11 of the first detection segment Tx by the rotation detection circuit 110, the control circuit 103 determines that the main drive pulse P1 has a reserve driving capacity, and hence determines the state of rotation using the first detection segment Tx (that is, the first segment T11 and the second segment T21), thereby performing pulse control. Also, if the control circuit 103 determines that the induced signal VRs exceeding the reference threshold voltage Vcomp is detected in the first segment T11 of the first detection segment Tx by the rotation detection circuit 110, the control circuit 103 determines that the main drive pulse P1 has no reserve driving capacity, and hence determines the state of rotation using the second detection segment Ty (that is, the first segment T11, the second segment T2, and the third segment T3), thereby performing pulse control.

When the XY-coordinate space where a main magnetic pole of the rotor 202 is situated by its rotation is divided into the first to fourth quadrants I to IV about the rotor 202, the first segment T11 and the second segment T21 of the first detection segment Tx, and the first segment T11, the second segment T2, and the third segment T3 of the second detection segment Ty are expressed as follows.

In the state of the normal driving, the first segment T11 of the first detection segment Tx corresponds to a segment in which the first state of rotation of the rotor 202 in the normal direction is determined in the third quadrant III of the space around the rotor 202, the second segment T21 after the first segment T11 corresponds to a segment in which the first state of rotation in the normal direction and the first state of rotation in the reverse direction of the rotor 202 are determined in the third quadrant III. In the state of the normal driving, the third segment T3 of the second detection segment Ty corresponds to a segment in which the first state of rotation after the reverse rotation of the rotor 202 is determined in the third quadrant III.

The normal drive means the state of driving under the normal state. In this embodiment, the state in which the time-of-day hands (the hour hand 107, the minute hand 108, and the second hand 109) are driven with the predetermined main drive pulse P1 is considered to be a normal driving, which is a rotation with the main drive pulse P1 having reserve driving capacity for rotating the stepping motor 105 (rotation with reserve).

In the state in which the stepping motor is driven with the main drive pulse P1 with a load increased until there is no more reserve driving capacity from the state of the normal driving (moderate-load-increased driving), the first segment T11 of the second detection segment Ty corresponds to a segment in which the first state of rotation of the rotor 202 in the normal direction is determined in the second quadrant III of a space around the rotor 202, the second segment T2 after the first segment T11 corresponds to a segment in which the first state of rotation in the normal direction and the first state of rotation in the reverse direction of the rotor 202 are determined in the third quadrant III, and the third segment T3 after the second segment T2 corresponds to a segment in which the first state of rotation in the reverse direction and the state of rotation after the rotation in the reverse direction of the rotor 202 is determined in the third quadrant III, which is a rotation with the main drive pulse P1 having insufficient reserve capacity for rotating the stepping motor 105 (rotation with no reserve).

A state of driving with larger energy than in the normal driving (a state of driving with the main drive pulse P1 having a larger energy than the normal driving with a load of the normal driving applied thereto) (high-energy driving) is a rotation with the main drive pulse P1 having reserve capacity for rotating the stepping motor 105 (rotation with reserve).

A state of driving with the main drive pulse P1 with a load increased by a large amount from the state of the normal driving (large-load-increased driving) is a rotation with the main drive pulse P1 having least reserve capacity for rotating the stepping motor 105 (rotation with least energy).

A state of driving with the main drive pulse P1 with a load increased by an extremely large amount from the state of the normal driving (extremely-large-load-increased driving) is a driving with the main drive pulse P1 lacking energy for rotating the stepping motor 105, so that the stepping motor 105 cannot be driven (non-rotation).

The reference threshold voltage Vcomp is a reference voltage for determining the voltage level of the induced signal VRs generating in the stepping motor 105. The reference threshold voltage Vcomp is set in such a manner that the induced signal VRs exceeds the reference threshold voltage Vcomp when the rotor 202 performs a certain fast action as in the case where the stepping motor 105 rotates, and the induced signal VRs does not exceed the reference threshold voltage Vcomp when the rotor 202 does not perform the certain fast action as in the case where the stepping motor 105 does not rotate.

For example, in the state of the normal driving in FIG. 3, the induced signal VRs generated in the area b is detected in the first segment T11, the induced signal VRs generated in the area c is detected in the second segment T21. In this manner, since the reserve driving capacity remains in the normal driving state, the induced signal VRs is detected in the first detection segment Tx. Therefore, detection in the third segment T3 is not performed, and the state of rotation is determined on the basis of the induced signal VRs detected in the first segment T11 and the second segment T21 of the first detection segment Tx.

In the state of the moderate-load-increased driving in FIG. 3, the induced signal VRs generated in an area a is detected in the first segment T11, the induced signal VRs generated in an area b is detected in the second segment T2, and the induced signal VRs generated in an area c is detected in the second segment T2. In this manner, since the reserve driving capacity does not remain in the moderate-load-increased driving, the induced signal VRs is detected in the second detection segment Ty. Therefore, detection in the second segment T21 is not performed but is performed in the second segment T2, and the state of rotation is determined on the basis of the induced signal VRs detected in the first segment T11 and the second segment T2 of the second detection segment Ty.

The case where the rotation detection circuit 110 detects the induced signal VRs exceeding the reference threshold voltage Vcomp is expressed as a determination value “1”, and the case where the rotation detection circuit 110 cannot detect the induced signal VRs exceeding the reference threshold voltage Vcomp is expressed as a determination value “0”. In the example of the normal driving shown in FIG. 3, since the determination value in the first segment T11 is “0”, it is determined that the reserve driving capacity might remain, and the state of rotation is determined using the first detection segment Tx. In this case, a pattern (0, 1) is obtained as a pattern indicating the state of rotation (the determination value in the first segment T11 and the determination value in the second segment T21). Therefore, the control circuit 103 determines that it is the normal driving (rotation with reserve), and performs pulse control to downgrade the energy of the main drive pulse P1 by a rank (downgrade).

In the example of the moderate-load-increased driving in FIG. 3, the determination value in the first segment T11 is “1”. Therefore, it is determined that there is no possibility of existence of reserve driving capacity, and the state of rotation is determined using the second detection segment Ty. In this case, a pattern (1, 1) is obtained as a pattern indicating the state of rotation (the determination value in the first segment T11 and the determination value in the second segment T2), and the control circuit 103 determines the driving to be moderate-load-increased driving (rotation with no reserve), and performs pulse control to maintain the energy of the main drive pulse P1 without change.

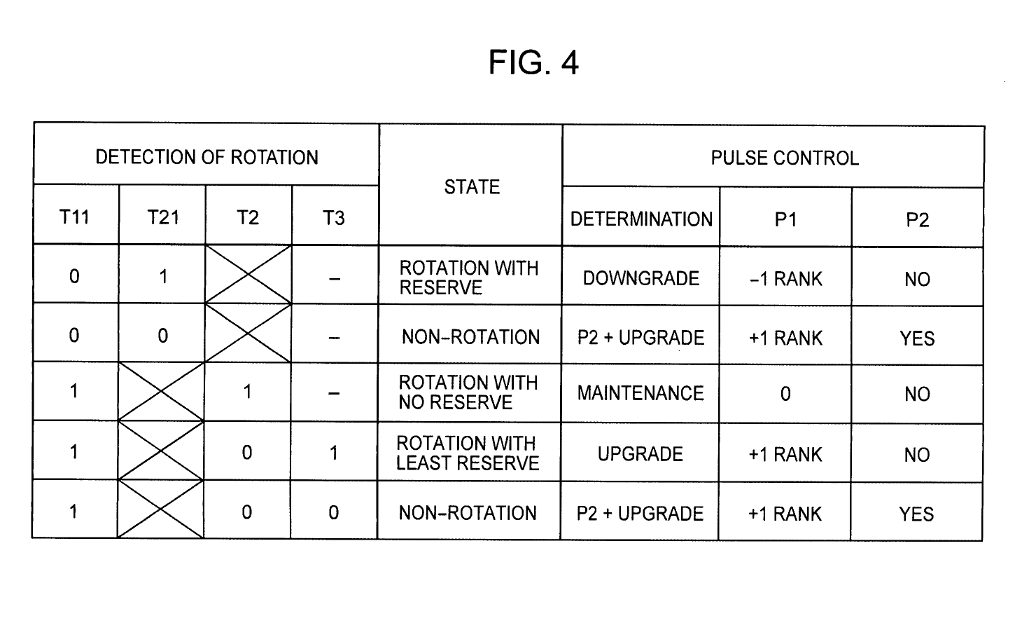

FIG. 4 is a determination chart showing all the actions in the first embodiment. In FIG. 4, as described above, the case where the induced signal VRs exceeding the reference threshold voltage Vcomp is detected is expressed as the determination value “1”, and the case where the induced signal VRs exceeding the reference threshold voltage Vcomp cannot be detected is expressed as the determination value “0”. The sign “−” represents the section which is not taken into consideration when determining the state of rotation.

As shown in FIG. 4, the rotation detection circuit 110 detects the presence or absence of the induced signal VRs exceeding the reference threshold voltage Vcomp. Then, the detection segment determination circuit 111 references the determination chart in FIG. 4 stored in the control circuit 103 on the basis of a pattern of determination of the segment where the induced signal VRs is generated. The control circuit 103 and the drive pulse selection circuit 104 control the rotation of the stepping motor 105 by performing the drive pulse control such as upgrade or downgrade for the main drive pulse P1, or the driving with the correction drive pulse P2, described later.

For example, in the case of a pattern (1, 0, 0), the first segment T11 is “1”, and hence the control circuit 103 determines the state of rotation using the second detection segment Ty. In this case, the control circuit 103 determines that the stepping motor 105 is not rotating (non-rotation), and controls the drive pulse selection circuit 104 so as to drive the stepping motor 105 with the correction drive pulse P2, and then controls the drive pulse selection circuit 104 so as to drive the stepping motor 105 next time with the main drive pulse P1 upgraded by a rank (upgrade).

In the case of a pattern (1, 0, 1), the control circuit 103 determines that the stepping motor 105 rotates but is in the driving state with a load increased by a large amount from the normal load (large-load-increased driving) and hence the stepping motor 105 may become a non-rotatable state when it is driven next time (rotation with least energy). Accordingly, the control circuit 103 does not perform the driving with the correction drive pulse P2, but controls the drive pulse selection circuit 104 so as to drive the stepping motor 105 next time with the main drive pulse P1 upgraded by a rank in an early stage before it becomes the non-rotatable state.

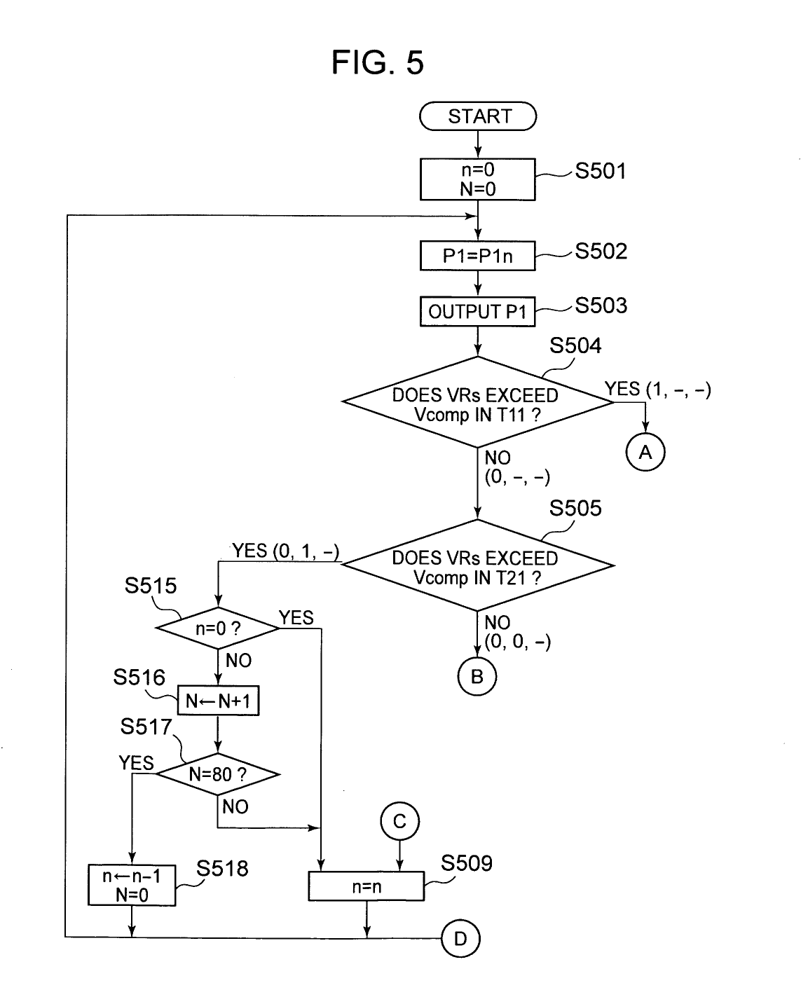

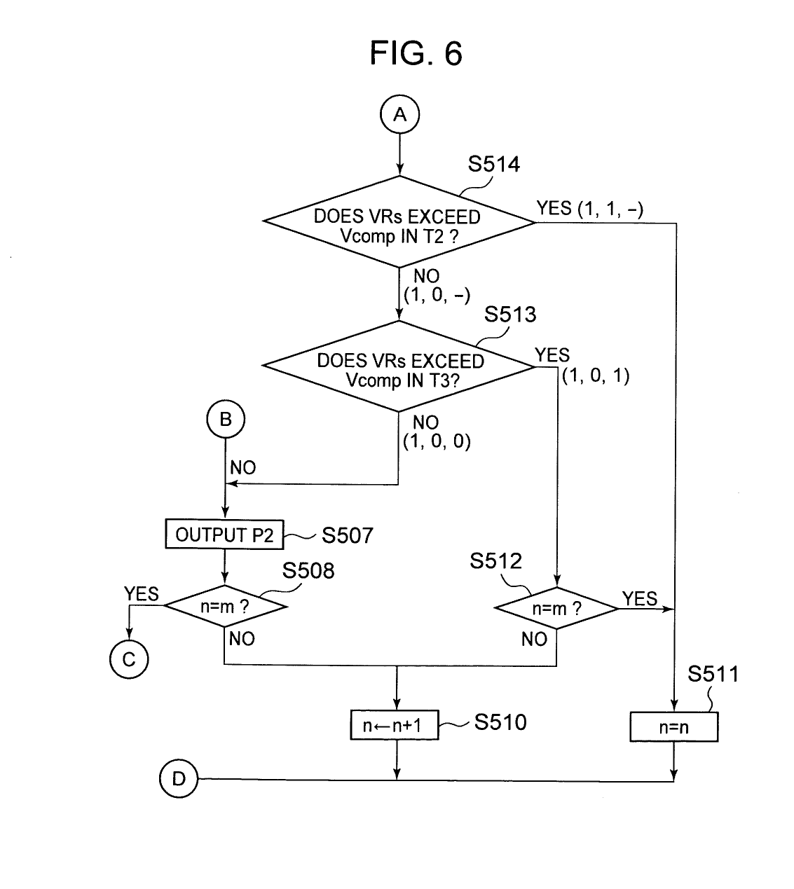

FIG. 5 and FIG. 6 are flowcharts showing the actions of the stepping motor control circuit and the analogue electronic watch according to the first embodiment. FIG. 5 is a flowchart showing a process specific for this embodiment, and FIG. 6 is a flowchart showing a process common to other embodiments, described later.

Referring now to FIG. 1 to FIG. 6, the actions of the stepping motor control circuit and the analogue electronic watch according to the first embodiment of the invention will be described in detail.

In FIG. 1, the oscillation circuit 101 generates a reference clock signal of a predetermined frequency, and the frequency divider circuit 102 divides the signal generated by the oscillation circuit 101 and generates a clock signal as a reference of time counting, and outputs the same to the control circuit 103.

The control circuit 103 counts the clock signal and performs a time counting action. Then, the control circuit 103 firstly sets a rank n of a main drive pulse P1n and the number of times N of continuous occurrence of the state of rotation with reserve drive capacity to zero (the driving state is a rotation with reserve or rotation with less reserve) (Step S501 in FIG. 5), and then outputs a control signal to rotate the stepping motor 105 with a main drive pulse P10 with a minimum pulse width (minimum energy rank) (Steps S502, S503).

The drive pulse selection circuit 104 rotates the stepping motor 105 with the main drive pulse P10 in response to a control signal from the control circuit 103. The stepping motor 105 is rotated with the main drive pulse P10 and then rotates the time-of-day hands 107 to 109. Accordingly, when the stepping motor 105 is normally rotated, the current time is always displayed by the time-of-day hands 107 to 109 in the analogue display unit 106.

The control circuit 103 performs determination whether or not the rotation detection circuit 110 detects the induced signal VRs of the stepping motor 105 exceeding the predetermined reference threshold voltage Vcomp, and whether or not the detection segment determination circuit 111 determines that a detected time t of the induced signal VRs falls within the first segment T11 of the first detection segment Tx (that is, determination whether or not the induced signal VRs exceeding the reference threshold voltage Vcomp is detected within the first segment T11 of the first detection segment Tx) (Step S504).

If the control circuit 103 determines that the induced signal VRs exceeding the reference threshold voltage Vcomp is not detected within the detection area in the first segment T11 in the process step S504 (It is a case of a pattern (0, −, −), where the determination value “−” means that the determination value is not fixed and either “1” or “0”.), the control circuit 103 determines that the determination value in the first segment T11 is “0” and hence there is a possibility of existence of reserve driving capacity. Therefore, the control circuit 103 determines the state of rotation using the first detection segment Tx.

In this case, the control circuit 103 determines whether or not the induced signal VRs exceeding the reference threshold voltage Vcomp is detected within the the second segment T21 of the first detection segment Tx in the same manner (Step S505).

If the control circuit 103 determines that the induced signal VRs exceeding the reference threshold voltage Vcomp is not detected within the second segment T21 in the process step S505 (It is a case of a pattern (0, 0, −), and the case of non-rotation in FIG. 3 and FIG. 4.), the control circuit 103 drives the stepping motor 105 with the correction drive pulse P2 (Step S507) and, if the rank n of the main drive pulse P1 is not a highest rank m, upgrades the main drive pulse P1 by a rank to a main drive pulse P1 (n+1). Then, the procedure goes back to the process step S502, and the main drive pulse P1 (n+1) is used for the next driving (Steps S508, S510).

If the rank n of the main drive pulse P1 is the highest rank m in the process step S508, the control circuit 103 cannot upgrade the main drive pulse P1, and hence the main drive pulse P1 is not changed. Then the procedure goes back to the process step S502, and this main drive pulse P1m is used for the next driving (Step S509).

If the control circuit 103 determines that the induced signal VRs exceeding the reference threshold voltage Vcomp is detected within the first segment T11 in the process step S504 (It is a case of a pattern (1, −, −).), the control circuit 103 determines that the determination value in the first segment T11 is “1” and hence there is no possibility of existence of the reserve driving capacity. Therefore, the control circuit 103 determines the state of rotation using the second detection segment Ty.

In this case, the control circuit 103 determines whether or not the induced signal VRs exceeding the reference threshold voltage Vcomp is detected within the second segment T2 of the second detection segment Ty in the same manner (Step S514).

If the control circuit 103 determines that the induced signal VRs exceeding the reference threshold voltage Vcomp is not detected within the second segment T2 in the process step S514 (It is a case of a pattern (1, 0, −).), the control circuit 103 determines whether or not the induced signal VRs exceeding the reference threshold voltage Vcomp is detected within the third segment T3 (Step S513).

If the control circuit 103 determines that the induced signal VRs exceeding the reference threshold voltage Vcomp is not detected within the third segment T3 in the process step S513 (It is a case of the pattern (1, 0, 0), and the case of non-rotation in FIG. 4.), the procedure goes to the process step S507 to perform the above-described process.

If the control circuit 103 determines that the induced signal VRs exceeding the reference threshold voltage Vcomp is detected within the third segment T3 in the process step S513 (It is a case of the pattern (1, 0, 1), and the case of the large-load-increased driving, and the rotation with least energy in FIG. 3 and FIG. 4.) and if the rank n of the main drive pulse P1 is not the maximum rank m, the control circuit 103 upgrades the main drive pulse P1 by a rank, and the procedure goes back to the process step S502 (Steps S512, S510). If it is the maximum rank m, the rank cannot be upgraded and hence the procedure goes back to the process step S502 (Steps S512, S511) without changing the rank.

If the control circuit 103 determines that the induced signal VRs exceeding the reference threshold voltage Vcomp is detected within the second segment T2 in the process step S514 (It is a case of a pattern (1, 1, −), and the case of the moderate-load-increased driving, and the rotation with no reserve in FIG. 3 and FIG. 4.), the procedure goes back to step S502 without changing the rank of the main drive pulse P1 (Step S511).

In contrast, if the control circuit 103 determines that the induced signal VRs exceeding the reference threshold voltage Vcomp is detected within the second segment T21 in the process step S505 (It is a case of a pattern (0, 1, −), which is a case of the normal driving or the high-energy driving, and is the rotation with reserve in FIG. 3 and FIG. 4.), and if the rank n of the main drive pulse P1 is the lowest rank 0 (Step S515), the rank cannot be downgraded. Therefore, the procedure goes back to the process step S502 without changing the rank (Step S509).

If the control circuit 103 determines that the rank n of the main drive pulse P1 is not the lowest rank 0 in the process step S515, the number of times N is incremented by one (Step S516). If the control circuit 103 determines that the number of times N after the increment reaches a predetermined number of times (80 times in this embodiment) (Step S517), the main drive pulse P1 is downgraded by a rank, the number of times N is set to zero, and the procedure goes back to the process step S502 (Step S518). If the control circuit 103 determines that the number of times N does not reach the predetermined number of times, the main drive pulse P1 is not changed and the procedure goes back to the process step S502 (Step S509). Accordingly, since the downgrade is performed when the driving state with the main drive pulse having reserve driving capacity occurs continuously by a predetermined number of times, the downgrade is performed under a stable driving state. Therefore, the stepping motor is prevented from becoming non-rotatable state due to the shortage of the energy after the downgrade and power saving is achieved.

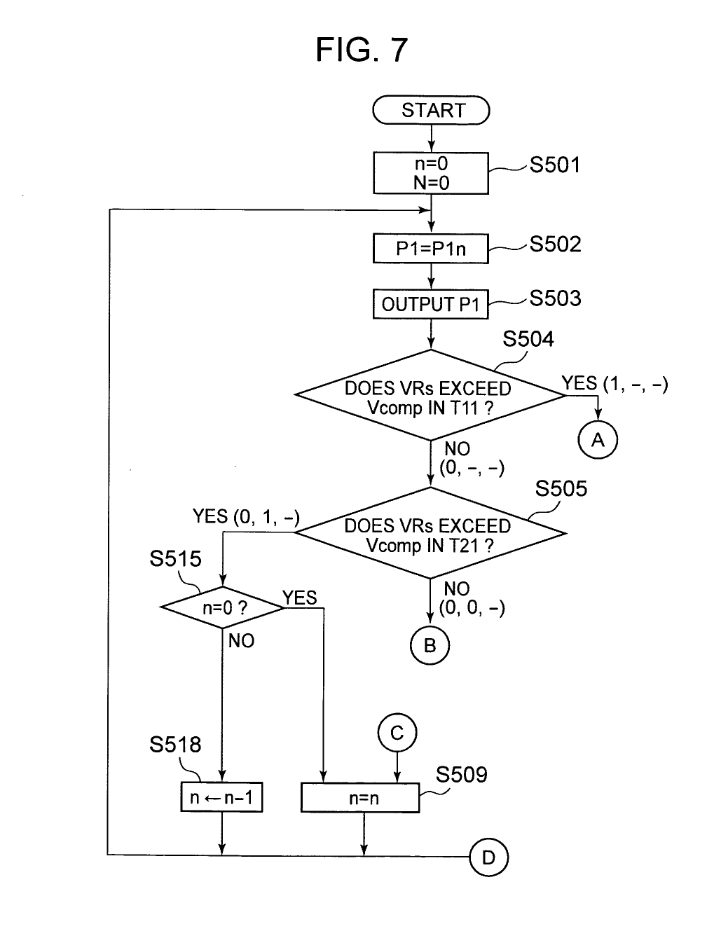

FIG. 7 is a flowchart showing actions in a second embodiment of the invention in conjunction with FIG. 6.

A different point of the second embodiment from the above-described embodiment is a process shown in FIG. 7, and the configuration such as the block diagram is the same. Referring now to FIG. 1 to FIG. 4, FIG. 6, and FIG. 7, the different points will be described.

If the control circuit 103 determines that the induced signal VRs exceeding the reference threshold voltage Vcomp is detected within the second segment T21 in the process step S505 in FIG. 7 and when the rank n of the main drive pulse P1 is the lowest rank 0 (Step S515), the rank cannot be downgraded and hence the procedure goes back to the process step S502 without changing the rank (Step S509).

If the control circuit 103 determines that the rank n of the main drive pulse P1 is not the lowest rank 0 in the process step S515, the rank of the main drive pulse P1 is downgraded by a rank immediately, and the procedure goes to the process step S502 (Step S518). Accordingly, since the downgrade is performed when the driving state with the main drive pulse having reserve driving capacity occurs once, a significant power saving is achieved.

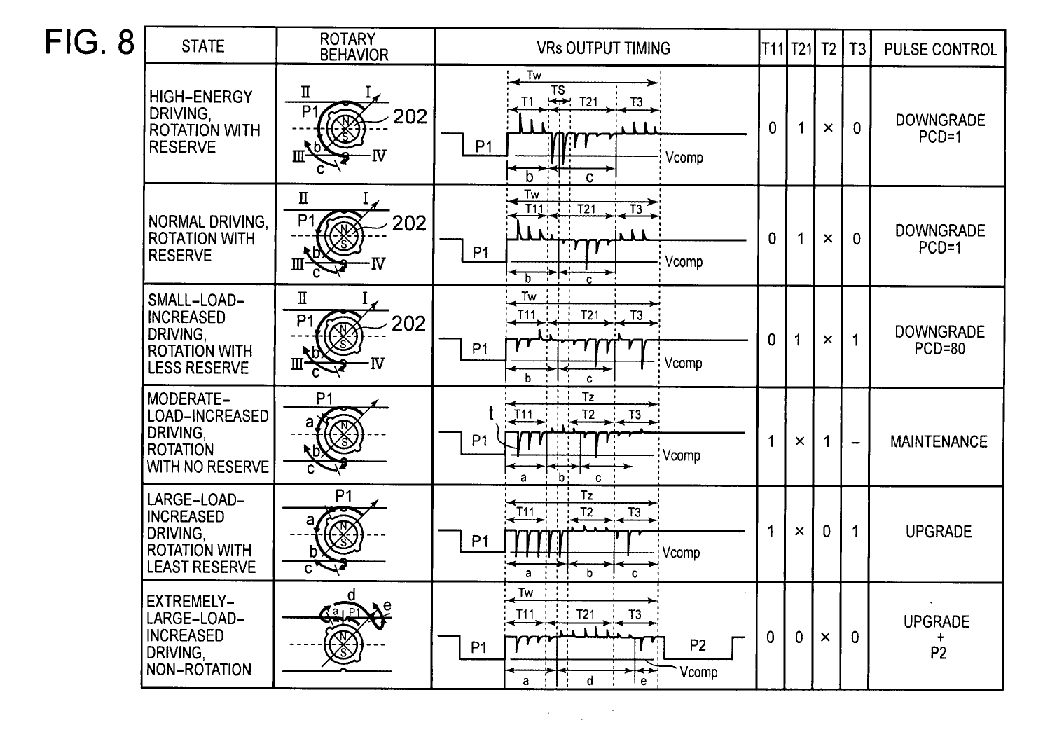

FIG. 8 is a timing chart for explaining the action of the stepping motor control circuit and the analogue electronic watch according to a third embodiment of the invention. The block diagram of the third embodiment is the same as FIG. 1, and the stepping motor used here is the same stepping motor as that shown in FIG. 2.

In the first embodiment described-above, the state of rotation of the stepping motor 105 is determined using the first detection segment Tx having the two segments T11 and T21 and the second detection segment Ty having the three segments T11, T2, and T3 as the detection segments. In contrast, in the third embodiment, the state of rotation of the stepping motor is determined using a first detection segment Tw having a plurality of segments (the three segments T11, T21, and T3 in the third embodiment) and a second detection segment Tz having a plurality of segments (the three segments T11, T2, and T3 in the third embodiment) are used as the detection segments. In the first detection segment Tw and the second detection segment Tz, the first segment T11 and the third segment T3 are commonly used, and the second segment T21 and the second segment T2 are different.

In other words, the first detection segment Tw includes the first segment T11, which is a predetermined time immediately after the drive with the main drive pulse P1, the second segment T21, which is a predetermined time after the first segment T11, and the third segment T3, which is a predetermined time after the second segment T11. In this manner, the first detection segment Tw starting immediately after the drive with the main drive pulse P1 is divided into continuous plurality of segments.

The second detection segment Tz includes the first segment T11, which is a predetermined time immediately after the drive with the main drive pulse P1, the second segment T2, which is a predetermined time after the first segment T11, and the third segment T3, which is a predetermined time after the second segment T2. In this manner, the second detection segment Tz starting immediately after the drive with the main drive pulse P1 is divided into the plurality of segments. The ineffective area Ts is provided between the first segment T11 and the second segment T2 of the second detection segment Tz, so that the second segment T2 of the second detection segment Ty starts after the second segment T21 of the first detection segment Tw.

In this embodiment, the first segment T1 and the third segment T3 in the second detection segment Tz use the first segment T11 and the third segment T3 of the first detection segment Tw. However, it may be set to segments having other lengths. Although the numbers of the segments of the first detection segment Tw and the second detection segment Tz are set to be the same, they do not necessarily have to be the same number.

When the XY-coordinate space where a main magnetic pole of the rotor 202 is situated by its rotation is divided into first to fourth quadrants I to IV about the rotor 202, the first segment T11 and the second segments T21, and T3 of the first detection segment Tw, and the first segment T11, the second segment T2, and the third segment T3 of the second detection segment Tz are expressed as follows.

In the state of the normal driving, the first segment T11 of the first detection segment Tw corresponds to a segment in which the first state of rotation of the rotor 202 in the normal direction is determined in the third quadrant III of the space around the rotor 202, the second segment T21 after the first segment T11 corresponds to a segment in which the first state of rotation in the normal direction and the first state of rotation in the reverse direction of the rotor 202 are determined in the third quadrant III, and the third segment T3 after the second segment T21 corresponds to a segment in which the state of rotation after the first rotation of the rotor 202 in the reverse direction is determined in the third quadrant III.

In the state in which the stepping motor is driven with the main drive pulse P1 with a load increased until there is no more reserve driving capacity from the state of the normal driving (moderate-load-increased driving), the first segment T11 of the second detection segment Tz corresponds to a segment in which the first state of rotation of the rotor 202 in the normal direction is determined in the second quadrant II, the second segment T2 after the first segment T11 corresponds to a segment in which the first state of rotation in the normal direction and the first state of rotation in the reverse direction of the rotor 202 are determined in the third quadrant III, and the third segment T3 after the second segment T2 corresponds to a segment in which the first state of rotation in the reverse direction and the state of rotation after the rotation in the reverse direction of the rotor 202 are determined in the third quadrant III, which is a rotation in which the energy of the main drive pulse P1 has insufficient reserve for rotating the stepping motor 105 (rotation with no reserve).

For example, in the example of the normal driving in FIG. 8, the determination value in the first segment T11 of the first detection segment Tw is “0”. Therefore, it is determined that there is the possibility of existence of reserve driving capacity, and the state of rotation is determined using the first detection segment Tw. In this case, a pattern (0, 1, 0) is obtained as the pattern indicating the state of rotation (the determination value in the first segment T11, the determination value in the second segment T21, and the determination value in the third segment T3), and the control circuit 103 determines the driving to be the normal driving (rotation with reserve), and performs pulse control to downgrade the energy of the main drive pulse P1 by a rank (downgrade) immediately at a moment when the state having a large reserve driving capacity occurs once.

In the example of the moderate-load-increased driving in FIG. 8, the determination value in the first segment T11 of the first detection segment Tw is “1”. Therefore, it is determined that there is no possibility of existence of reserve driving capacity, and the state of rotation is determined using the second detection segment Tz. In this case, a pattern (1, 1) is obtained as a pattern indicating the state of rotation (the determination value in the first segment T11 and the determination value in the second segment T2), and the control circuit 103 determines the driving to be moderate-load-increased driving (rotation with no reserve), and performs pulse control to maintain the energy of the main drive pulse P1 without change.

In the example of the small-load-increased driving in FIG. 8, the determination value in the first segment T11 of the first detection segment Tw is “0”. Therefore, it is determined that there is the possibility of existence of reserve driving capacity, and the state of rotation is determined using the first detection segment Tw. In this case, a pattern (0, 1, 1) is obtained as a pattern indicating the state of rotation (the determination value in the first segment T11, the determination value in the second segment T21, and the determination value in the third segment T3), and the control circuit 103 determines the driving to be the small-load-increased driving (rotation with less reserve), and performs pulse control to downgrade the energy of the main drive pulse P1 by a rank (pulse down control) when the state in which the reserve drive capacity is small occurs continuously by a predetermined number of times (for example, 80 times).

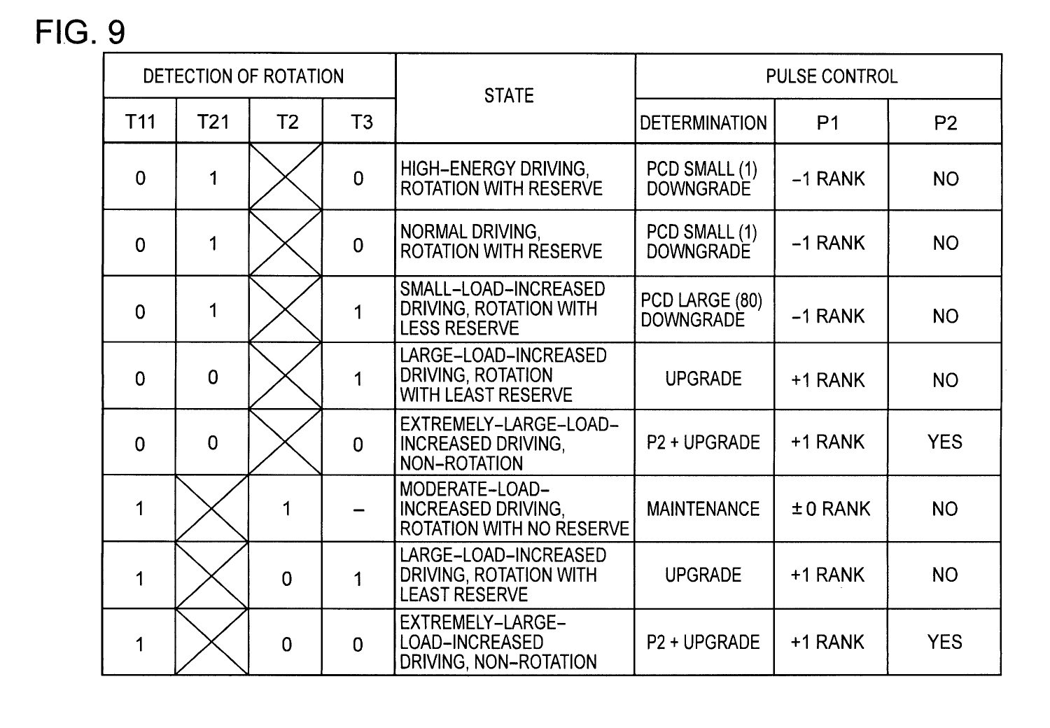

FIG. 9 is a determination chart showing all the actions in the third embodiment. The meanings of the signs in FIG. 9 are the same as those in FIG. 4.

For example, if the pattern is (1, 0, 0), the first segment T11 is “1”, and hence the control circuit 103 determines the state of rotation using the second detection segment Tz. In this case, the control circuit 103 determines that the stepping motor 105 is not rotating (non-rotation), and controls the drive pulse selection circuit 104 so as to drive the stepping motor 105 with the correction drive pulse P2, and then controls the drive pulse selection circuit 104 so as to drive the stepping motor 105 next time with the main drive pulse P1 which is upgraded by a rank (upgrade).

In the case of a pattern (1, 0, 1), the control circuit 103 determines that the stepping motor 105 rotates but is in the driving state with a load increased by a large amount from the normal load (large-load-increased driving) and hence the stepping motor 105 may become a non-rotatable state when it is driven next time (rotation with least energy). Accordingly, the control circuit 103 does not perform the driving with the correction drive pulse P2, but controls the drive pulse selection circuit 104 so as to drive the stepping motor 105 with the main drive pulse P1 upgraded by a rank next time in an early stage before it becomes the non-rotatable state.

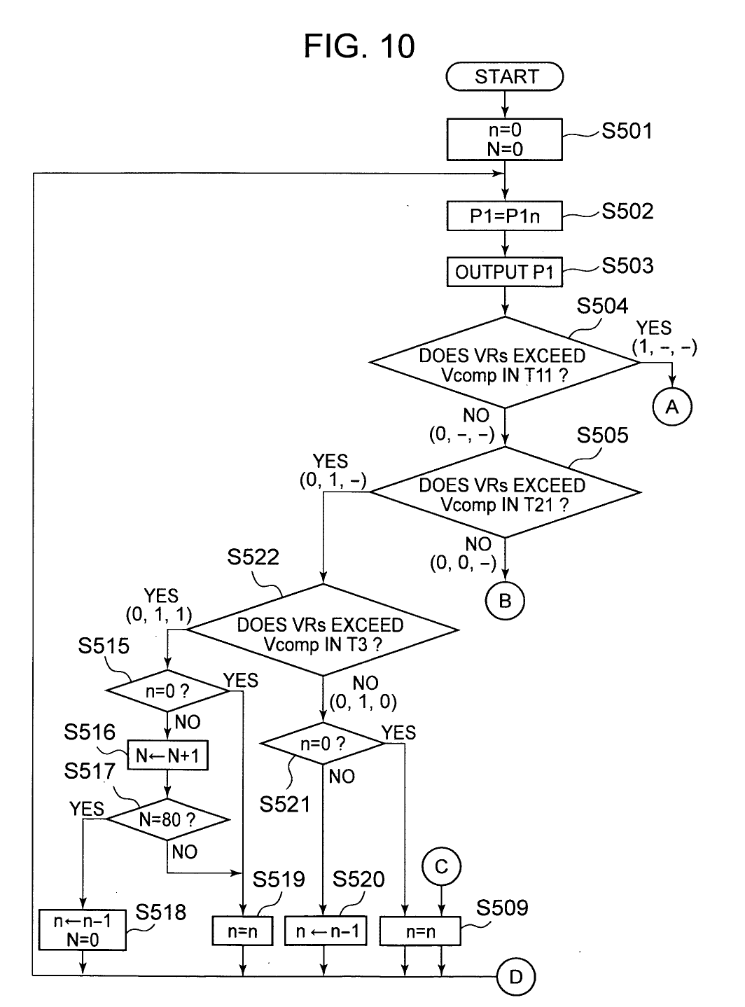

FIG. 10 is a flowchart showing an action of the third embodiment in conjunction with FIG. 6, and the same processes as in FIG. 5 are designated by the same reference numerals.

Referring now to FIG. 1, FIG. 2, and FIG. 8 to FIG. 10, the different points from the first embodiment will be described.

In process step S505 in FIG. 10, if the control circuit 103 determines that the induced signal VRs exceeding the reference threshold voltage Vcomp is detected within in the second segment T21 (It is a case of the pattern (0, 1, −), which is a case of the small-load-increased driving, the normal driving, or the high-energy driving, and is the rotation with less reserve or rotation with reserve in FIG. 8 and FIG. 9.), whether or not the induced signal VRs exceeding the reference threshold voltage Vcomp is detected within the third segment T3 is determined (Step S522).

In contrast, if the control circuit 103 determines that the induced signal VRs exceeding the reference threshold voltage Vcomp is not detected within in the third segment T3 in the process step S522 (It is a case of the pattern (0, 1, 0), which is a case of the normal driving or the high-energy driving, and is the rotation with reserve in FIG. 8 and FIG. 9.), and if the rank of the main drive pulse P1 is not the lowest rank 0, the main drive pulse P1 is downgraded by a rank immediately when the state having a large drive capacity occurs once and the procedure goes back to process step S502 (Steps S521, S520) and, when the rank of the main drive pulse P1 is the lowest rank 0, the rank is not changed because the rank cannot be lowered, and hence the procedure goes back to the process step S502 (Step S509). In this manner, the main drive pulse 21 is downgraded immediately when the state of rotation having a large reserve driving capacity occurs once, power saving is achieved.

If the control circuit 103 determines that the induced signal VRs exceeding the reference threshold voltage Vcomp is detected within the third segment T3 in the process step S522 (It is a case of the pattern (0, 1, 1), which is a case of the small-load-increased driving, and is the rotation with less reserve in driving capacity in FIG. 8 and FIG. 9), and if the rank of the main drive pulse 21 is the lowest rank 0 (Step S515), the rank cannot be downgraded and hence the procedure goes back to the process step S502 without changing the rank (Step S519).

If the control circuit 103 determines that the rank n of the main drive pulse P1 is not the lowest rank 0 in the process step S515, the number of times N is incremented by one (Step S516). If the control circuit 103 determines that the number of times N after the increment reaches a predetermined number of times (80 times in this embodiment) (Step S517), the main drive pulse P1 is downgraded by a rank, the number of times N is set to zero, and the procedure goes back to the process step S502 (Step S518). If the control circuit 103 determines that the number of times N does not reach the predetermined number of times, the main drive pulse P1 is not changed and the procedure goes back to the process step S502 (Step S519). Accordingly, since the downgrade is performed when the state of rotation having a small reserve driving capacity occurs continuously by a predetermined number of times, the downgrade is performed under a stable driving state. Therefore, the stepping motor is prevented from becoming non-rotatable state due to the shortage of the energy after the downgrade and power saving is achieved.

As described thus far, the stepping motor control circuit according to the respective embodiments described above includes the rotation detection circuit 110 configured to detect the induced signal VRs generated by the rotation of the rotor 202 of the stepping motor 105 and detect whether or not the induced signal VRs exceeds the predetermined reference threshold voltage Vcomp in the detection segment having a plurality of the segments, and the control unit configured to determine the state of rotation of the stepping motor 105 on the basis of the pattern indicating whether or not the induced signals VRs detected by the rotation detection circuit 110 in the plurality of the segments exceed the reference threshold voltage Vcomp and, on the basis of the result of determination, drive the stepping motor 105 with any one of the plurality of main drive pulses P1 different from each other in energy or the correction drive pulse P2 having larger energy than the main drive pulses P1, wherein a plurality of types of the detection segments are provided as the detection segments, and the control unit is configured to select any one of the detection segments according to the extent of the reserve driving capacity of the main drive pulse P1 and determine the state of rotation of the stepping motor 105 using the pattern in the selected detection segment, and control the driving of the stepping motor 105 with any one of the plurality of main drive pulses P1 having different energies or the correction drive pulse P2 having a larger energy than the respective main drive pulses P1 on the basis of the result of determination.

Also, according to the result of detection of the segment immediately after the driving with the main drive pulse P1, the detection timing for the second segment is changed to detect the state of rotation having the reserve driving capacity.

Therefore, even when the timing of generation of the induced signal VRs is changed due to the relative change of the drive energy with respect to the load, the accurate detection of the state of rotation is enabled and the adequate pulse control is enabled.

In addition, the control of the plurality of drive pulses being different in drive energy is achieved without the possibility of erroneous determination with a simple configuration.

Furthermore, even when the stepping motor is driven with the main drive pulse P1 having an excess of energy in comparison with the load in a case where an energy-variable range of the main drive pulse P1 is set to a wide range, the state of rotation can be determined accurately.

In the first to the third embodiments, since the ineffective area Ts is provided in a predetermined area (between the first segment and the second segment in the respective embodiments), even when the load of the stepping motor 105 and the drive energy of the drive pulse are relatively fluctuated and hence the induced signal VRs occurs before and after the timing when it is supposed to occur with fluctuations, the erroneous determination of the state of rotation caused by the fluctuation of the timing of generation of the induced signal VRs is prevented.

For example, even when the induced signal VRs which is to be generated in the second segment is generated in an early stage in the first segment in the case where the energy of the main drive pulse P1 exceeds the predetermined value with the provision of the ineffective area Ts in the rear area of the first segment T1, the induced signal VRs falls within the ineffective area Ts. Therefore, accurate determination of the state of rotation and the normal pulse control are achieved. With the provision of the ineffective area Ts across the rear area of the first segment and the front area of the second segment, the same effect as described above is achieved. In addition, even when the induced signal VRs is generated in retard when the energy of the main drive pulse P1 is the predetermined value or smaller, the induced signal VRs falls within the ineffective area Ts. Therefore, accurate determination of the state of rotation and the normal pulse control are achieved.

According to the respective embodiments described above, the control unit is configured to determine the state of rotation without considering the induced signal VRs generated in the ineffective area Ts. Therefore, the rotation detection circuit 110 does not necessarily have to detect the induced signal VRs in the ineffective area Ts.

The rotation detection circuit 110 by itself is a known circuit configured to detect the induced signal VRs by repeating a state in which the a loop is formed by inserting a detection element for detecting the induced signal VRs generated by the stepping motor 105 in series with the coil 209 (detection loop (RS loop)), and a state in which a loop is formed by short-circuiting the coil 209 of the stepping motor 105 to apply damping (closed loop) at a predetermined cycle.

Therefore, the rotation detection circuit 110 may be configured to maintain the controlled state of the stepping motor 105 in the detection loop or maintain the controlled state of the stepping motor 105 in the closed loop. The configuration of the rotation detection circuit 110 may also be modified to perform an action to repeat the detection loop and the closed loop alternately at predetermined regular intervals in the ineffective area Ts, but not to detect the induced signal VRs, or not to use the induced signal VRs detected in the ineffective area Ts for determination of the state of rotation.

In fourth to sixth embodiments described later, a plurality of types of ineffective areas having lengths different from each other are prepared as the ineffective areas Ts, and the control circuit 103 selects a type of the ineffective area Ts according to the reserve rotation capacity to control the rotation detecting operation of the rotation detection circuit 110 or the segment determining operation of the detection segment determination circuit 111. In the case of an ineffective area Ts1 having a predetermined length, the rotation detection circuit 110 drives the stepping motor 105 so as to form the closed loop in response to the control of the control circuit 103. In contrast, in the case of an ineffective area Ts2 having a predetermined length longer than the ineffective area Ts, the rotation detection circuit 110 drives the stepping motor 105 so as to form the detection loop. In this manner, by changing the length of the ineffective area Ts or the state of the loop according to the reserve rotation capacity, the rotation detection circuit 110 is enabled to detect the timing of generation of the induced signal VRs accurately to improve the accuracy of the detection of rotation.

Subsequently, the fourth embodiment of the invention will be described. The configuration and action of the fourth embodiment are the same as those shown in FIG. 1, FIG. 2, FIG. 4, and FIG. 6 in the first embodiment shown above, and only the different points will be described below.

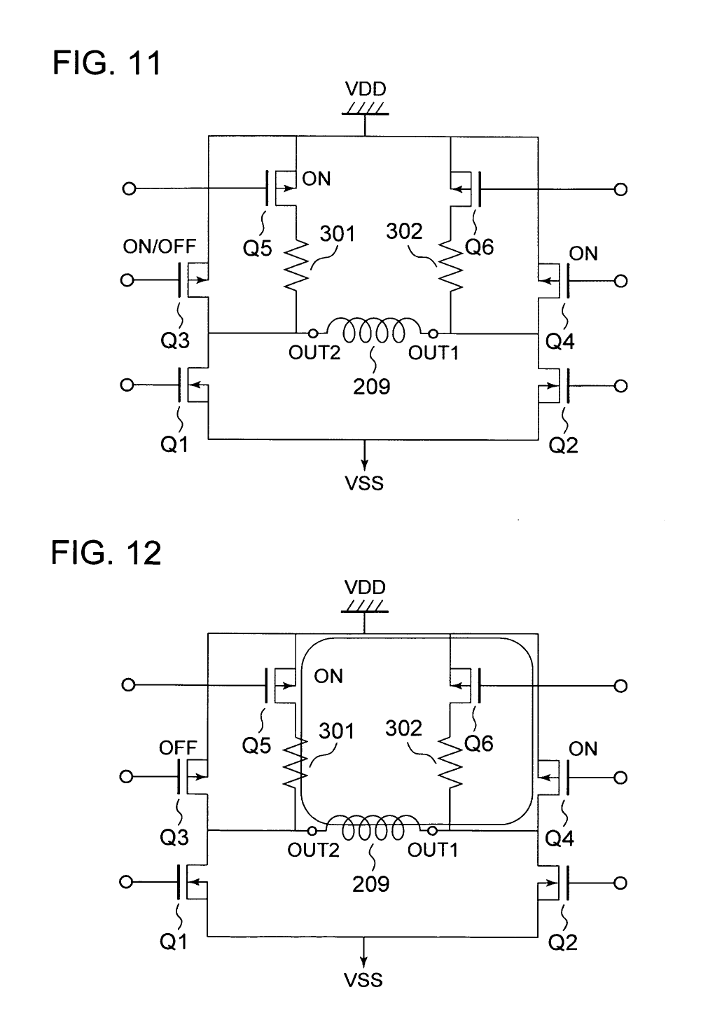

FIG. 11 is a circuit diagram showing part of the drive pulse selection circuit 104 and the rotation detection circuit 110 in detail, and having a known configuration.

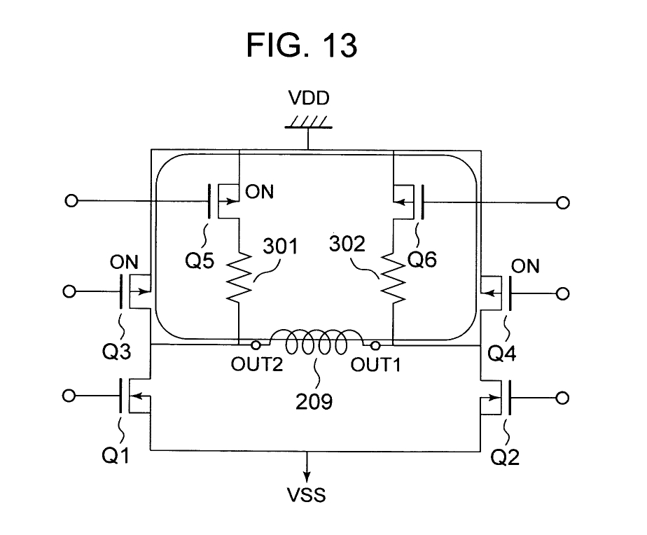

FIG. 12 and FIG. 13 are explanatory drawings showing rotation detecting actions for detecting the state of rotation of the stepping motor 105.

FIG. 12 is a drawing showing the state in which the detection loop is configured, which corresponds to a state in which the detection element for detecting the induced signal VRs (detection resistances 301 or 302) are connected in series with the coil 209 of the stepping motor 105 to form a loop.

FIG. 13 is a drawing showing the state in which the closed loop is configured, which corresponds to a state in which the coil 209 of the stepping motor 105 is short-circuited to form a loop.

In FIG. 11, P channel MOS transistors Q1 and Q2 and N channel MOS transistors Q3 and Q4 are components of the drive pulse selection circuit 104. The coil 209 of the stepping motor 105 is connected between a source connecting point between the transistor Q1 and the transistor Q3, and a source connecting point between the transistor Q2 and the transistor Q4.

In contrast, N channel MOS transistor Q3 to Q6, the detection resistance 301 connected in series with the transistor Q5, and the detection resistance 302 connected in series with the transistor Q6 are components of the rotation detection circuit 110.

The gates of the respective transistors Q1 to Q6 are turned ON and OFF by the control circuit 103. The second terminal OUT2 between the detection resistance 301 and the coil 209 and the first terminal OUT1 between the detection resistance 302 and the coil 209 are connected to input units of a comparator (not shown) in the rotation detection circuit 110. The predetermined reference threshold voltage Vcomp is supplied to a reference input unit of the comparator, and whether or not the induced signal VRs detected by the comparator exceeds the predetermined reference threshold voltage Vcomp is determined.

The transistor Q3 constitutes a first switch element, the transistor Q1 constitutes a second switch element, the transistor Q4 constitutes a third switch element, the transistor Q2 constitutes a fourth switch element, the transistor Q5 constitutes a fifth switch element, the transistor Q6 constitutes a sixth switch element, the detection resistance 301 constitutes the first detection element, and the detection resistance 302 constitutes the second detection element. The transistor Q5 and the detection resistance 301 constitute a first series circuit, and the transistor Q6 and the detection resistance 302 constitute a second series circuit.

In the case of rotating the stepping motor 105 in the rotating period in which the stepping motor 105 is rotated, a current is supplied to the coil 209 in the normal direction or in the reverse direction by turning the transistors Q2 and Q3 ON simultaneously or turning the transistors Q1 and Q4 ON simultaneously in response to the rotation detection control pulse from the control circuit 103, thereby rotating the stepping motor 105.

In a case of detecting the induced signal VRs generated in the stepping motor 105 by the rotation in the detection segment T following the rotating period, a detection signal generated in the detection resistance 301 by switching the transistor Q3 between ON and OFF at predetermined regular intervals in a state in which the transistors Q4 and Q5 are held in the ON state in response to the rotation detection control pulse for detecting the rotation supplied from the control circuit 103 (the signal corresponding to the induced signal VRs generated by the rotation of the stepping motor 105) is retrieved and compared with the reference threshold voltage Vcomp, or a detection signal generated in the detection resistance 302 by switching the transistor Q4 between ON and OFF at predetermined regular intervals in a state in which the transistors Q3 and Q6 are held in the ON state (the signal corresponding to the induced signal VRs generated by the rotation of the stepping motor 105) is retrieved and compared with the reference threshold voltage Vcomp. Accordingly, the rotation detection circuit 110 detects whether or not the induced signal VRs exceeding the reference threshold voltage Vcomp is generated in the detection segment T.

In other words, in the case of detecting the induced signal VRs in the detection segment T, a state in which the transistor Q3 is turned OFF in a state in which the transistors Q4 and Q5 are held in the ON state in response to the rotation detection control pulse supplied from the control circuit 103 (the detection loop in FIG. 12) and a state in which the transistor Q3 is turned ON in a state in which the transistors Q4 and Q5 are held in the ON state (the closed loop in FIG. 13) are repeated alternately at predetermined regular intervals. Alternatively, in a state where the transistors Q3 and Q6 are held in the ON state in response to the rotation detection control pulse supplied from the control circuit 103, the transistor Q4 is switched to ON and OFF at a predetermined cycle (that is, the detection loop and the closed loop are repeated alternately at a predetermined cycle).

At this time, in the state of the detection loop, the loop is formed by the transistors Q4 and Q5, the detection resistance 301, the coil 209, or the transistors Q3 and Q6, the detection resistance 302, and the coil 209. Therefore, the stepping motor 105 is not damped.

However, in the state of the closed loop, the loop is formed by the transistors Q3 and Q4, and the coil 209, and the coil 209 is short-circuited. Therefore, the stepping motor 105 is damped, and the free oscillations of the stepping motor 105 are restrained.

In the fourth embodiment, the type of the detection segment, the length of the ineffective area Ts, and the loop state in the ineffective area Ts are changed according to whether or not the reserve rotation capacity after the driving of the stepping motor 105 is large.

More specifically, when the induced signal VRs is “0” in the first segment of the detection segment T, it is determined that the reserve rotating capacity exceeds a predetermined value (large reserve rotation capacity), and the control is made to set the detection segment T to first detection segment Tx, the ineffective area to the ineffective area Ts1 having a length of a first predetermined value, and the loop in the ineffective area Ts1 to closed loop. In this manner, when the drive energy of the main drive pulse P1 is larger enough than the drive energy required for rotating the stepping motor 105 (large reserve rotation capacity), the damping is applied in the ineffective area Ts1, so that the free oscillations of the rotor 202 are restrained in a short time and the stable detection of rotation is achieved.

When the induced signal VRs is “1” in the first segment of the detection segment T, it is determined that the reserve capacity of the drive energy of the main drive pulse P1 is the predetermined value or smaller (small reserve rotation capacity) with respect to the drive energy required for rotating the stepping motor 105, and control is made to set the detection segment T to the second detection segment Ty, the ineffective area to the ineffective area Ts2 having the length of a second predetermined value longer than the first predetermined value, and the loop to the detection loop in the ineffective area Ts2. In this manner, occurrence of such event that the speed of rotation is lowered by using the long ineffective area Ts2 when the reserve rotation capacity is small, so that the induced signal VRs generated in the segment T11 is shifted to the segment T2 and hence is erroneously detected and downgraded erroneously is prevented.

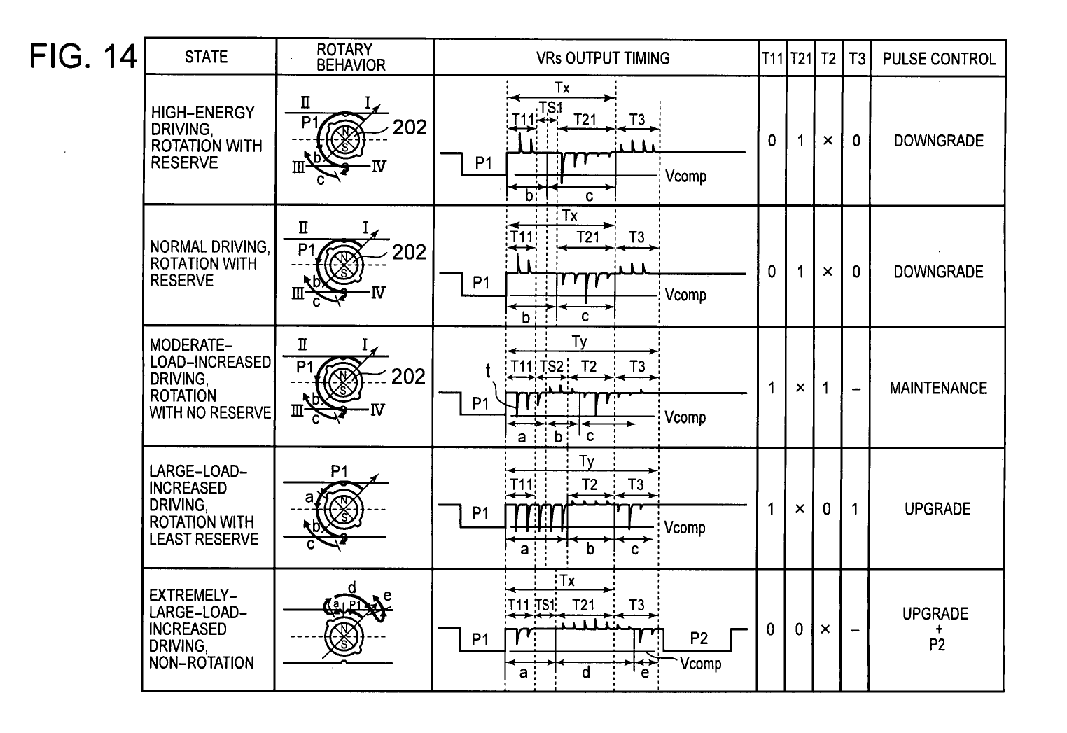

FIG. 14 is a timing chart showing a case where the stepping motor 105 is driven with the main drive pulse P1 in the fourth to sixth embodiments of the invention, which corresponds to FIG. 3.

In FIG. 14, when the first segment T11 is “0” as described above (including the large reserve rotation capacity), the first detection segment Tx is used as the detection segment. Also, the ineffective area Ts1 having a short length, that is, the first predetermined length, is used as the ineffective area, and the stepping motor 105 is controlled to the closed loop in the ineffective area Ts1. Therefore, the induced signal VRs is not generated in the ineffective area Ts.

When the first segment T11 is “1” (when the reserve rotation capacity is small), the second detection segment Ty is used as the detection segment. Also, the ineffective area Ts2 having a length longer than the ineffective area Ts1 by a predetermined length is used as the ineffective area, and the stepping motor 105 is controlled to the detection loop in the ineffective area Ts2. Therefore, the induced signal VRs is generated in the ineffective area Ts2.

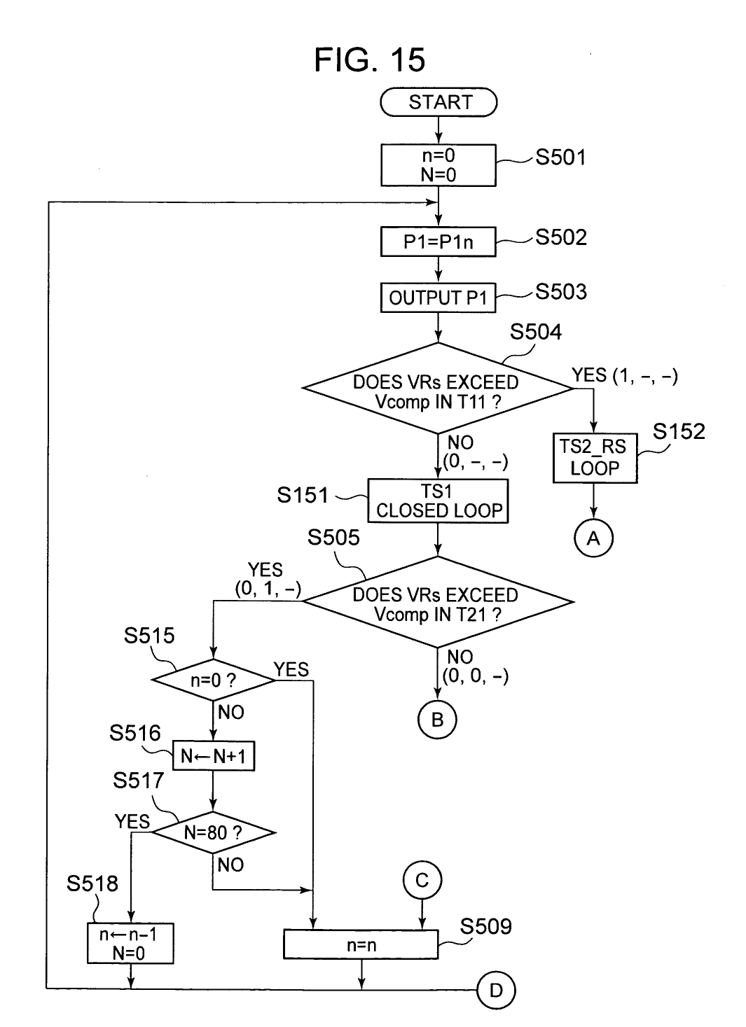

FIG. 15 is a flowchart showing the process in the fourth embodiment.

Referring now to FIG. 1, FIG. 2, FIG. 4, FIG. 6, and FIG. 11 to FIG. 15, the actions in the fourth embodiment different from the first embodiment will be described.

If the control circuit 103 determines that the induced signal VRs exceeding the reference threshold voltage Vcomp is not detected within the first segment T11 in the process step S504 (It is a case of the pattern (0, −, −), where the determination value “−” means that the determination value is not fixed and either “1” or “0”.), the control circuit 103 determines that the determination value in the first segment T11 is “0” and hence there is a possibility of existence of the reserve rotation capacity. Therefore, the control circuit 103 determines the state of rotation using the first detection segment Tx, and forms the closed loop in the ineffective area Ts1 of the first detection segment Tx (Step S151 in FIG. 15).

The rotation detection circuit 110 detects the induced signal VRs using the first detection segment Tx and forms the closed loop in the ineffective area Ts1 unless otherwise the detection segment is changed in response to the control of the control circuit 103 from the process step S151 onward. In contrast, the detection segment determination circuit 111 determines the segment in which the induced signal VRs exceeding the reference threshold voltage Vcomp is generated using the first detection segment Tx unless otherwise the detection segment is changed in response to the control of the control circuit 103 from the process step S151 onward.

On the other hand, if the control circuit 103 determines that the induced signal VRs exceeding the reference threshold voltage Vcomp is detected within the first segment T11 in the process step S504 (It is a case of the pattern (1, −, −).), the control circuit 103 determines the determination value in the first segment T11 to be “1” and hence there is no possibility of existence of reserve rotation capacity. Therefore, the control circuit 103 determines the state of rotation using the second detection segment Ty, and forms the detection loop in the ineffective area Ts2 of the second detection segment Ty (Step S152).

The rotation detection circuit 110 detects the induced signal VRs using the second detection segment Ty unless otherwise the detection segment is changed in response to the control of the control circuit 103 from the process step S152 onward, and forms the detection loop in ineffective area Ts2. In contrast, the detection segment determination circuit 111 determines the segment in which the induced signal VRs exceeding the reference threshold voltage Vcomp is generated using the second detection segment Ty unless otherwise the detection segment is changed in response to the control of the control circuit 103 from the process step S152 onward.

The processes in FIG. 15 and FIG. 6 are performed as described above.

As described above, according to the fourth embodiment, the rotation detection circuit 110 is configured to damp the stepping motor 105 by forming the closed loop in the ineffective area Ts1 when the reserve rotation capacity of the stepping motor 105 exceeds the predetermined value when the rotation is detected. The rotation detection circuit 110 is configured to form the detection loop in the ineffective area Ts2 when the reserve rotation capacity of the stepping motor 105 is the predetermined value or smaller when the rotation is detected.

In this manner, by changing the state of the loop in the ineffective area Ts according to the magnitude of reserve rotation capacity, the rotation detection circuit 110 is enabled to detect the timing of generation of the induced signal VRs accurately and improvement of the accuracy of the detection of rotation is enabled.

The period to form the closed loop and the period to form the detection loop in the ineffective area Ts are differentiated according to the magnitude of the reserve rotation capacity (In the fourth embodiment, the length of the closed loop is shorter than the length of the detection loop.). Therefore, when the reserve rotation capacity is large, early detection is enabled by damping the stepping motor. There is also such an advantage that occurrence of such event that the speed of rotation is lowered when the reserve rotation capacity is small, and the induced signal VRs generated in the segment T11 is shifted to the segment T2 and hence is erroneously detected and downgraded erroneously is prevented.

Subsequently, the fifth embodiment of the invention will be described.

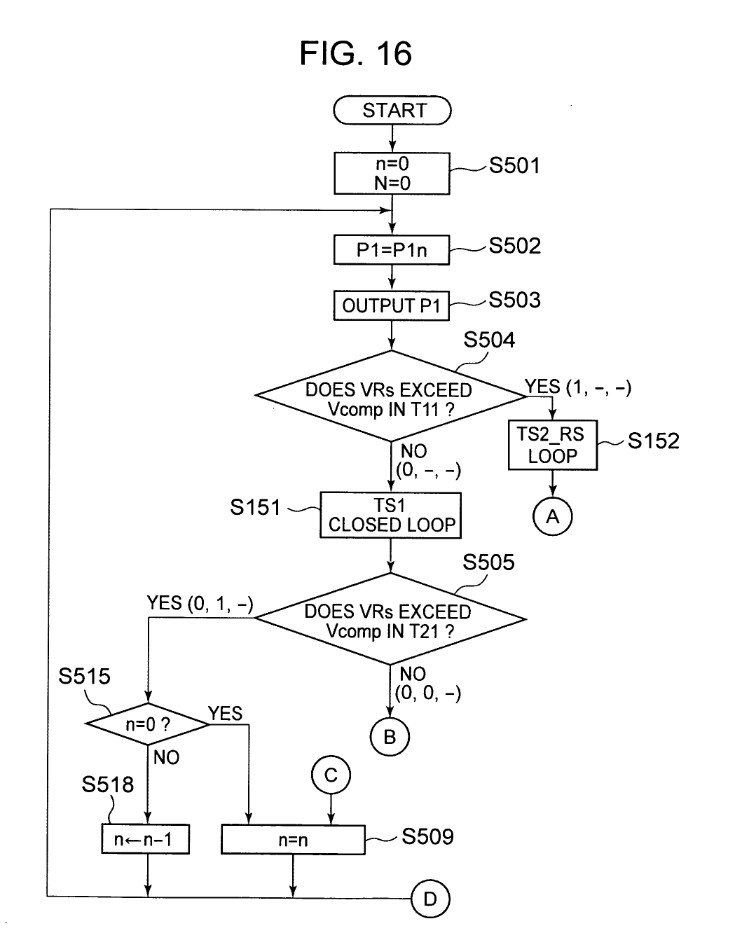

FIG. 16 is a flowchart showing the process in the fifth embodiment, which is a process to perform the pulse control action in conjunction with the flowchart in FIG. 6. Other configurations and actions are the same as those in the second embodiment.

Referring now to FIG. 1, FIG. 2, FIG. 4, FIG. 6, FIG. 11 to FIG. 14, and FIG. 16, the actions in the fifth embodiment different from the second embodiment will be described.

If the control circuit 103 determines that the induced signal VRs exceeding the reference threshold voltage Vcomp is not detected within the first segment T11 in the process step S504 (It is a case of the pattern (0, −, −), where the determination value “−” means that the determination value is not fixed and either “1” or “0”.), the control circuit 103 determines that the determination value in the first segment T11 is “0” and hence there is a possibility or existence of the reserve rotation capacity. Therefore, the control circuit 103 determines the state of rotation using the first detection segment Tx, and forms the closed loop in the ineffective area Ts1 of the first detection segment Tx (Step S151 in FIG. 16).

In response to the control of the control circuit 103, the rotation detection circuit 110 detects the induced signal VRs using the first detection segment Tx unless otherwise the detection segment is changed, and forms the closed loop in the ineffective area Ts1 from the process step s151 onward. In contrast, the detection segment determination circuit 111 determines the segment in which the induced signal VRs exceeding the reference threshold voltage Vcomp is generated using the first detection segment Tx unless otherwise the detection segment is changed in response to the control of the control circuit 103 from the process step S151 onward.

On the other hand, if the control circuit 103 determines that the induced signal VRs exceeding the reference threshold voltage Vcomp is detected within the first segment T11 in the process step S504 (It is a case of the pattern (1, −, −).), the control circuit 103 determines that the determination value in the first segment T11 is “1” and hence there is no possibility of existence of reserve rotation capacity. Therefore, the control circuit 103 determines the state of rotation using the second detection segment Ty, and forms the detection loop in the ineffective area Ts2 of the second detection segment Ty (Step S152).

The rotation detection circuit 110 detects the induced signal VRs using the second detection segment Ty unless otherwise the detection segment is changed in response to the control of the control circuit 103 from the process step S152 onward, and forms the detection loop in ineffective area Ts2. In contrast, the detection segment determination circuit 111 determines the segment in which the induced signal VRs exceeding the reference threshold voltage Vcomp is generated using the second detection segment Ty unless otherwise the detection segment is changed in response to the control of the control circuit 103 from the process step S152 onward.

The processes in FIG. 16 and FIG. 6 are performed as described above.

As described above, according to the fifth embodiment, by changing the state of the loop in the ineffective area Ts according to the magnitude of reserve rotation capacity, the rotation detection circuit 110 is enabled to detect the timing of generation of the induced signal VRs accurately and improvement of the accuracy of the detection of rotation is enabled as in the fourth embodiment. The period to form the closed loop and the period to form the detection loop in the ineffective area Ts are differentiated according to the magnitude of the reserve rotation capacity. Therefore, when the reserve rotation capacity is large, early detection is enabled by damping the stepping motor. There is also such an advantage that occurrence of such event that the speed of rotation is lowered when the reserve rotation capacity is small, and the induced signal VRs generated in the segment T11 is shifted to the segment T2 and hence is erroneously detected and downgraded erroneously is prevented.

Subsequently, the sixth embodiment of the invention will be described.

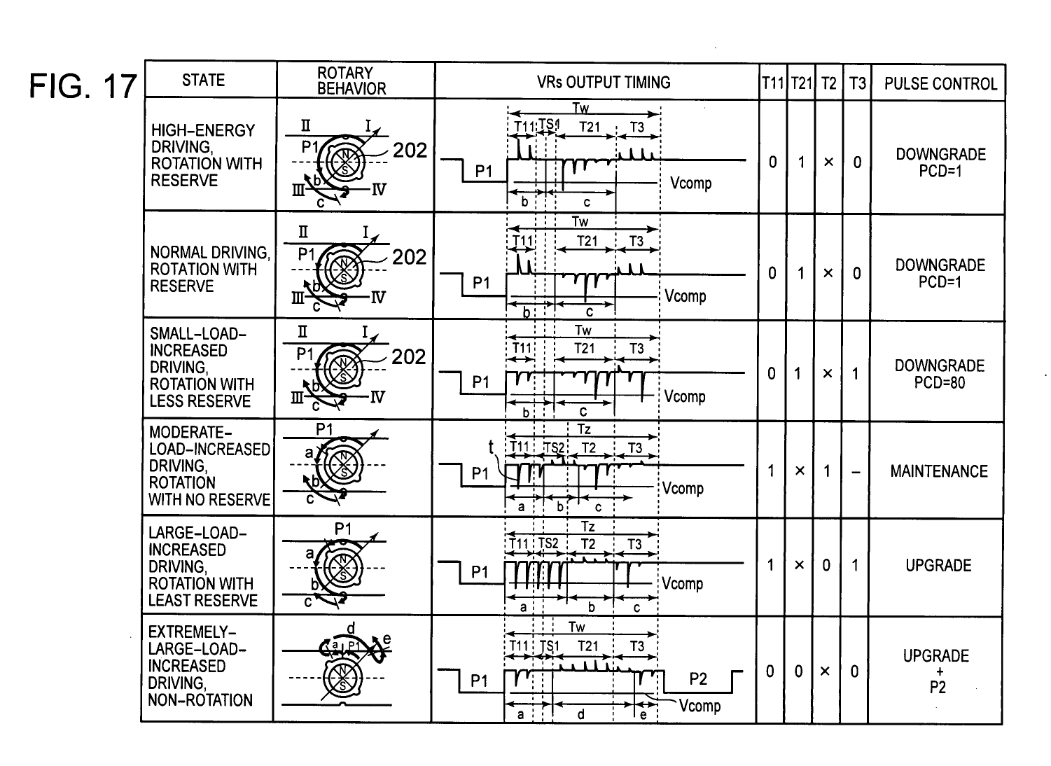

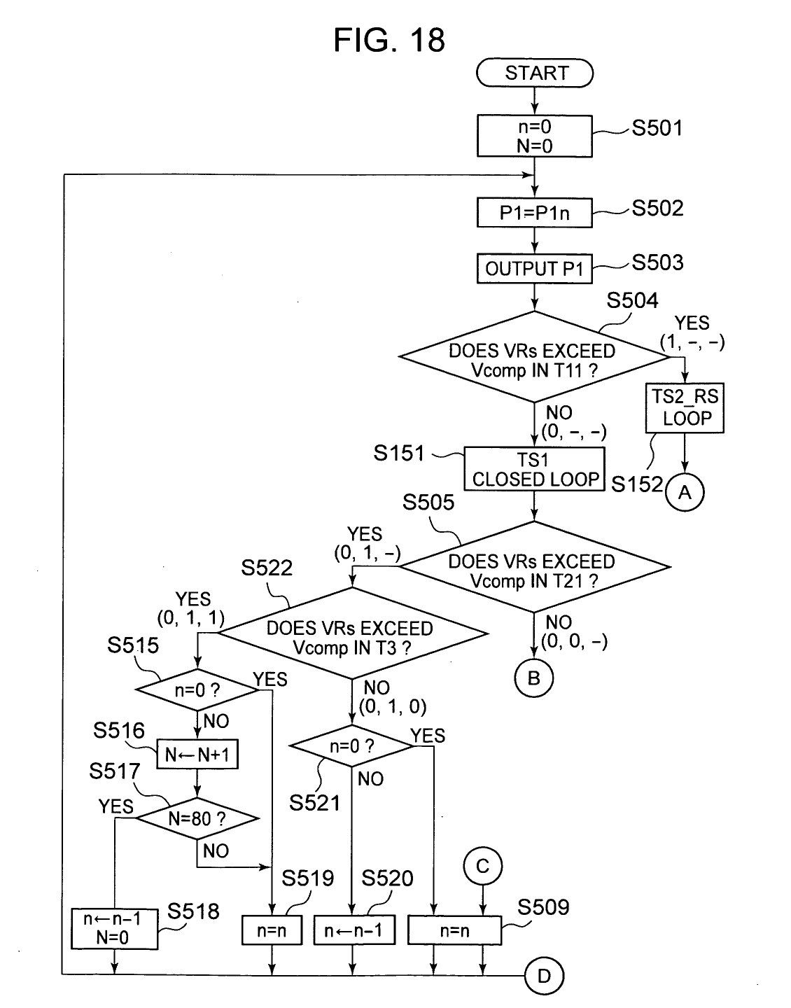

FIG. 17 is a timing chart for explaining the action of the stepping motor control circuit and the analogue electronic watch according to the sixth embodiment of the invention. FIG. 18 is a flowchart showing the process in the sixth embodiment, which is a process to perform the pulse control action in conjunction with the flowchart in FIG. 6. Other configurations and actions are the same as those in the third embodiment.

Referring now to FIG. 1, FIG. 2, FIG. 4, FIG. 6, FIG. 11 to FIG. 13, FIG. 17, and FIG. 18, the actions in the sixth embodiment different from the third embodiment will be described.

If the control circuit 103 determines that the induced signal VRs exceeding the reference threshold voltage Vcomp is not detected within the first segment T11 in the process step S504 (It is a case of the pattern (0, −, −), where the determination value “−” means that the determination value is not fixed and either “1” or “0”.), the control circuit 103 determines that the determination value in the first segment T11 is “0” and hence there is a possibility of existence of reserve rotation capacity. Therefore, the control circuit 103 determines the state of rotation using the first detection segment Tw, and forms the closed loop in the ineffective area Ts1 of the first detection segment Tw (Step S151 in FIG. 18).

The rotation detection circuit 110 detects the induced signal VRs using the first detection segment Tw unless otherwise the detection segment is changed in response to the control of the control circuit 103 from the process step S151 onward, and forms the closed loop in the ineffective area Ts1. In contrast, the detection segment determination circuit 111 determines the segment in which the induced signal VRs exceeding the reference threshold voltage Vcomp is generated using the first detection segment Tw unless otherwise the detection segment is changed in response to the control of the control circuit 103 from the process step S151 onward.

If the control circuit 103 determines that the induced signal VRs exceeding the reference threshold voltage Vcomp is detected within the first segment T11 in the process step S504 (It is a case of the pattern (1, −, −).), the control circuit 103 determines that the determination value in the first segment T11 is “1” and hence there is no possibility of existence of reserve rotation capacity. Therefore, the control circuit 103 determines the state of rotation using the second detection segment Tz, and forms the detection loop in the ineffective area Ts2 of the second detection segment Tz (Step S152).

The rotation detection circuit 110 detects the induced signal VRs using the second detection segment Tz unless otherwise the detection segment is changed in response to the control of the control circuit 103 from the process step S152 onward, and forms the detection loop in the ineffective area Ts2. In contrast, the detection segment determination circuit 111 determines the segment in which the induced signal VRs exceeding the reference threshold voltage Vcomp is generated using the second detection segment Tz unless otherwise the detection segment is changed in response to the control of the control circuit 103 from the process step S152 onward.

The processes in FIG. 18 and FIG. 6 are performed as described above.

As described above, according to the sixth embodiment, by changing the state of the loop in the ineffective area Ts according to the magnitude of reserve rotation capacity, the rotation detection circuit 110 is enabled to detect the timing of generation of the induced signal VRs accurately and improvement of the accuracy of the detection of rotation is enabled as in the fourth embodiment. The period to form the closed loop and the period to form the detection loop in the ineffective area Ts are differentiated according to the magnitude of the reserve rotation capacity. Therefore, when the reserve rotation capacity is large, early detection is enabled by damping the stepping motor. In addition, occurrence of such event that the induced signal VRs which is supposed to be generated in the third segment T3 is generated earlier, and is erroneously detected in the second segment T21 is prevented. There is also such an advantage that occurrence of such event that the speed of rotation is lowered when the reserve rotation capacity is small, the induced signal VRs generated in the segment T11 is shifted to the segment T2 and hence is erroneously detected and downgraded erroneously is prevented.

According to the analogue electronic watch in the embodiment of the invention, the analogue electronic watch includes the stepping motor configured to rotate the time-of-day hands and a stepping motor control circuit configured to control the stepping motor and is characterized in that the stepping motor control circuits according to any one of the embodiments described above is employed as the stepping motor control circuit. Therefore, there is an effect such that the state of rotation is detected accurately even when the timing of generation of the induced signal is changed due to the relative change of the drive energy with respect to the load, and accurate clocking drive is enabled.

In the respective embodiments described above, the energy of the respective main drive pulses P1 is changed by differentiating the pulse width. However, the driving energy can be changed also by changing the number of comb-teeth pulses, or by changing the pulse voltage.

Also, although the analogue electronic watch has been described as the example of the application of the stepping motor, it may be applicable to electronic instruments which use the motor.

The stepping motor control circuit according to the invention may be applicable to various electronic instruments using the stepping motor.

The analogue electronic watch according to the invention is applicable to various analogue electronic watches such as analogue electronic wrist watches, or analogue electronic standing clocks.

What is claimed is:

1. A stepping motor control circuit comprising: a rotation detection unit configured to detect an induced signal generated by the rotation of a rotor of a stepping motor and detect whether or not the induced signal exceeds a predetermined reference threshold voltage in a detection segment having a plurality of segments; and a control unit configured to determine the state of rotation of the stepping motor on the basis of the pattern indicating whether or not the induced signals detected by the rotation detection unit in the plurality of segments exceed the reference threshold voltage and, on the basis of the result of determination, control the driving of the stepping motor with any one of a plurality of main drive pulses different from each other in energy or a correction drive pulse having larger energy than the main drive pulse,
wherein a plurality types of the detection segments are provided as the detection segments, and
the control unit selects one of the detection segments and determines the state of rotation of the stepping motor using the pattern in the selected detection segment according to the extent of the reserve driving capacity of the main drive pulse, and controls the driving of the stepping motor with any one of the plurality of main drive pulses having energies different from each other or the correction drive pulse having energy larger than the respective main drive pulses on the basis of the result of determination.

2. A stepping motor control circuit according to claim 1, wherein the plurality of types of detection segments includes a first detection segment having a plurality of segments and a second detection segment having a plurality of segments including a segment different from at least one of the first detection segment, and
the control unit determines the extent of the reserve driving capacity on the basis of the result of detection in a predetermined segment in the first detection segment, selects the first detection segment or the second detection segment on the basis of the result of determination, and determines the state of rotation of the stepping motor using the pattern in the selected detection segment.

3. A stepping motor control circuit according to claim 2, wherein the predetermined segment is used both for the first detection segment and the second detection segment.

4. A stepping motor control circuit according to claim 2, wherein the predetermined segment is a first segment provided at first immediately after driving of the main drive pulse,
the control unit determines the extent of the reserve driving capacity on the basis of the result of detection in the first segment in the first detection segment, selects whether detection is continued in the first detection segment or detection target is switched to the second detection segment for detection on the basis of the result of determination, and determines the state of rotation of the stepping motor using the pattern in the selected detection segment.

5. A stepping motor control circuit according to claim 3, wherein the predetermined segment is a first segment provided at first immediately after driving of the main drive pulse,
the control unit determines the extent of the reserve driving capacity on the basis of the result of detection in the first segment in the first detection segment, selects whether detection is continued in the first detection segment or detection target is switched to the second detection segment for detection on the basis of the result of determination, and determines the state of rotation of the stepping motor using the pattern in the selected detection segment.

6. A stepping motor control circuit according to claim 2, wherein the second segment provided after the first segment in the first detection segment is started earlier than the second segment provided after the first segment in the second detection segment.

7. A stepping motor control circuit according to claim 3, wherein the second segment provided after the first segment in the first detection segment is started earlier than the second segment provided after the first segment in the second detection segment.

8. A stepping motor control circuit according to claim 4, wherein the second segment provided after the first segment in the first detection segment is started earlier than the second segment provided after the first segment in the second detection segment.

9. A stepping motor control circuit according to claim 2, wherein the first detection segment includes at least two segments, and the second detection segment includes at least three segments.

10. A stepping motor control circuit according to claim 2, wherein the first detection segment and the second detection segment include the same number of segments.

11. A stepping motor control circuit according to claim 2, wherein in the state of the normal driving, the first segment of the first detection segment corresponds to a segment in which the first state of rotation of the rotor in the normal direction is determined in the third quadrant of the space around the rotor, the second segment after the first segment corresponds to a segment in which the first state of rotation in the normal direction and the first state of rotation in the reverse direction of the rotor are determined in the third quadrant.

12. A stepping motor control circuit according to claim 2, wherein in a moderate-load-increased driving state in which the stepping motor is driven with the main drive pulse with a load increased until there is no more reserve driving capacity from the state of the normal driving, the first segment of the second detection segment corresponds to a segment in which the first state of rotation of the rotor in the normal direction is determined in the second quadrant of a space around the rotor, the second segment after the first segment corresponds to a segment in which the first state of rotation in the normal direction and the first state of rotation in the reverse direction of the rotor are determined in the third quadrant, and the third segment after the second segment corresponds to a segment in which the first state of rotation in the reverse direction and the state of rotation after the rotation in the reverse direction of the rotor are determined in the third quadrant.

13. A stepping motor control circuit according to claim 1, wherein if the state of rotation having a large reserve driving capacity occurs once when the stepping motor is driven with the main drive pulse, the control unit downgrades the main driving pulse.

14. A stepping motor control circuit according to claim 1, wherein if the state of rotation having a small reserve driving capacity occurs continuously by a predetermined number of times when the stepping motor is driven with the main drive pulse, the control unit downgrades the main driving pulse.

15. A stepping motor control circuit according to claim 1, wherein at least one type of the detection segment is provided with an ineffective area, and the control unit determines the state of rotation of the stepping motor without considering the induced signal generating in the ineffective area.

16. A stepping motor control circuit according to claim 15, wherein the control unit determines the state of rotation of the stepping motor by changing the length of the ineffective area to a length according to the magnitude of the reserve rotation capacity of the stepping motor.

17. A stepping motor control circuit according to claim 15, wherein the rotation detecting unit is configured to detect the induced signal by repeating a detection loop for detecting the induced signal generating in the stepping motor with a detection element and a closed loop for damping the stepping motor by short-circuiting the stepping motor at a predetermined cycle, and damp the stepping motor by forming the closed loop in the ineffective area when the reserve rotation capacity of the stepping motor is the predetermined value or smaller.

18. A stepping motor control circuit according to claim 15, wherein the rotation detecting unit is configured to detect the induced signal by repeating a detection loop for detecting the induced signal generating in the stepping motor with a detection element and a closed loop configured to damp the stepping motor by short-circuiting the stepping motor at a predetermined cycle, and damp the stepping motor by forming the detection loop in the ineffective area when the reserve rotation capacity of the stepping motor exceeds the predetermined value.

19. A stepping motor control circuit according to claim 18, wherein the length of the closed loop in the ineffective area is shorter than the length of the detection loop.

20. An analogue electronic watch having a stepping motor configured to rotate time-of-day hands, and a stepping motor control circuit configured to control the stepping motor,
wherein the stepping motor control circuit according to claim 1 is used as the stepping motor control circuit.
